(19) United States
(12) Patent Application Publication
(10) Pub. No.: US 2009/0150639 A1
(43) Pub. Date: Jun. 11, 2009

(54) MANAGEMENT APPARATUS AND MANAGEMENT METHOD

(76) Inventor: Hideo OHATA, Fujisawa (JP)

Correspondence Address: BRUNDIDGE & STANGER, P.C., 1700 DIAGONAL ROAD, SUITE 330, ALEXANDRIA, VA, 22314, US

(21) Appl. No.: 12/025,228

(22) Filed: Feb. 4, 2008

(30) Foreign Application Priority Data
Dec. 7, 2007 (JP) 2007-317539

(51) Int. Cl. G06F 12/00

(52) U.S. Cl. 711/172; 711/E12.001

(57) ABSTRACT

Proposed are a management apparatus and a management method capable of supporting and executing storage operation and management capable of improving the utilization ratio of storage resources. With this management apparatus for managing a storage apparatus equipped with a function for providing a virtual logical volume to a host system, and dynamically allocating a storage area to the virtual logical volume upon receiving a write request for writing data into the virtual logical volume, the capacity utilization of the virtual logical volume by a file system is acquired, the capacity utilization of the virtual logical volume configured from the capacity of the storage area allocated to the virtual logical volume is acquired, and the capacity utilization of the file system and the capacity utilization of the corresponding virtual logical volume are associated and displayed.

### CROSS REFERENCES

This application relates to and claims priority from Japanese Patent Application No. 2007-317539, filed on Dec. 7, 2007, the entire disclosure of which is incorporated herein by reference.

### BACKGROUND

The present invention generally relates to a management apparatus and a management method of a storage apparatus, and in particular relates to a management apparatus and a management method suitable for managing a storage apparatus that provides a virtual logical volume to a host system.

Conventionally, as one virtualization technology in a storage apparatus, there is technology referred to as AOU (Allocation On Use) which provides a virtual logical volume (sometimes simply referred to as a “virtual volume”) to a host system, and dynamically allocates a storage capacity to the virtual logical volume upon receiving a write request from the host system for writing data into the virtual logical volume (for instance, refer to Japanese Patent Laid-Open Publication No. 2003-15915).

In a standard logical volume (hereinafter referred to as a “real logical volume” or simply as a “real volume”), storage areas in the amount of the capacity defined at the time of creating the real volume are all secured in advance on a physical disk or in an array group. Meanwhile, with the AOU technology, only the capacity is defined during the creation of the virtual logical volume and the storage area for the virtual logical volume is not secured, and a storage area is allocated in a necessary amount only when a write request is issued to a new address of the virtual logical volume. The storage capacity that was or will be allocated to the virtual logical volume is secured in a dedicated area (hereinafter referred to as a “pool”) of the virtual logical volume.

A pool is defined as an aggregate of a plurality of real logical volumes. In the ensuing explanation, a plurality of real logical volumes configuring a pool is referred to as a “pool logical volume” or simply as a “pool volume.” A write request or a read request to the virtual logical volume is converted within the storage apparatus into a write request or a read request to the pool volume, and thereafter subject to processing.

According to the AOU technology, since it is not necessary to preliminarily prepare all storage areas in the capacity of the defined virtual logical volume, it will be possible to mount the required minimum number of physical disks upon introducing a storage apparatus by using the virtual logical volume, and thereafter add a physical disk if the storage capacity becomes insufficient according to the subsequent usage status thereof. As a result of increasing the utilization efficiency of disks as described above, it is possible to reduce the storage apparatus installation cost and operation cost.

### SUMMARY

Meanwhile, in the foregoing AOU technology, if the storage capacity required by the file system in the host server increases or decreases with time, the storage capacity in the storage apparatus that is no longer required as a result of the storage capacity decreasing will only be recorded as management information of the file system, and is never notified to the lower-level storage apparatus.

Thus, the storage apparatus will be maintained in a status where the unused storage capacity allocated to the file system remains allocated to the file system even though such storage capacity is not being used by the file system, and there is a problem in that the utilization efficiency of storage resources will deteriorate.

The present invention was made in view of the foregoing points. Thus, an object of the present invention is to propose a management apparatus and a management method capable of supporting and executing storage operation and management capable of improving the utilization ratio of storage resources.

In order to achieve the foregoing object, the present invention provides a management apparatus for managing a storage apparatus equipped with a function for providing a virtual logical volume to a host system, and dynamically allocating a storage area to the virtual logical volume upon receiving a write request for writing data into the virtual logical volume. This management apparatus comprises a first capacity utilization acquisition unit for acquiring the capacity utilization of the virtual logical volume by a file system in which data is stored in the virtual logical volume by the host system, a second capacity utilization acquisition unit for acquiring the capacity utilization of the virtual logical volume configured from the capacity of the storage area allocated to the virtual logical volume, and a display unit for associating and displaying the capacity utilization of the file system and the capacity utilization of the corresponding virtual logical volume respectively acquired by the first and second capacity utilization acquisition units.

The present invention additionally provides a management method for managing a storage apparatus equipped with a function for providing a virtual logical volume to a host system, and dynamically allocating a storage area to the virtual logical volume upon receiving a write request for writing data into the virtual logical volume. This management methods comprises a first step for acquiring the capacity utilization of the virtual logical volume by a file system in which data is stored in the virtual logical volume by the host system, and acquiring the capacity utilization of the virtual logical volume configured from the capacity of the storage area allocated to the virtual logical volume, and a second step for associating and displaying the capacity utilization of the file system and the capacity utilization of the corresponding virtual logical volume.

The present invention further provides a management apparatus for managing a storage apparatus equipped with a function for providing a virtual logical volume to a host system, and dynamically allocating a storage area to the virtual logical volume upon receiving a write request for writing data into the virtual logical volume. This management apparatus comprises a first capacity utilization acquisition unit for acquiring the capacity utilization of the virtual logical volume by a file system in which data is stored in the virtual logical volume by the host system, a second capacity utilization acquisition unit for acquiring the capacity utilization of the virtual logical volume configured from the capacity of the storage area allocated to the virtual logical volume, and a file system migration unit for migrating data of the file system, in which the difference between the capacity utilization and the capacity utilization of the corresponding virtual logical volume exceeds a predetermined threshold value, to another virtual logical volume, and deleting the virtual logical volume of the migration source.

The present invention additionally provides a management method for managing a storage apparatus equipped with a function for providing a virtual logical volume to a host system, and dynamically allocating a storage area to the virtual logical volume upon receiving a write request for writing data into the virtual logical volume. This management method comprises a first step for acquiring the capacity utilization of the virtual logical volume by a file system in which data is stored in the virtual logical volume by the host system, and acquiring the capacity utilization of the virtual logical volume configured from the capacity of the storage area allocated to the virtual logical volume, and a second step for migrating data of the file system, in which the difference between the capacity utilization and the capacity utilization of the corresponding virtual logical volume exceeds a predetermined threshold value, to another virtual logical volume, and deleting the virtual logical volume of the migration source.

According to the present invention, the gap (unused area) arising between the storage capacity required by the file system and the storage capacity to be used by a virtual volume to which the foregoing file system is allocated is detected, prioritized, and displayed as a list on a screen, or the unused area can be collected by migrating the data of the file system (copying of data to the new virtual volume and deletion of data from the old virtual volume). Thereby, it is possible to support and execute storage operation and management capable of improving the utilization ratio of storage resources.

As a method of avoiding a write error that occurs by the unused capacity of the pool to be allocated with the storage area of the virtual volume becoming depleted, the pool capacity can be expanded, or the unused area can be expanded by changing the virtual volume into a real volume. These methods, however, cannot be employed unless there is unused mounted capacity outside the pool. According to the present invention, since it is possible to collect the area of the pool that is unused by file system, depletion of the pool can be avoided even when the unused mounted capacity outside the pool is insufficient.

### DESCRIPTION OF DRAWINGS

FIG. 1 is a block diagram showing the overall configuration of a computer system according to an embodiment of the present invention;

FIG. 2 is a block diagram showing another configuration example of the computer system;

FIG. 3 is a block diagram showing a detailed configuration of storage management software;

FIG. 4 is a conceptual diagram showing a specific example concerning the configuration of resources and the relationship among resources in the storage system;

FIG. 5 is a schematic diagram schematically showing a configuration example of a migration plan display screen;

FIG. 6 is a schematic diagram schematically showing a configuration example of a migration plan display screen;

FIG. 7 is a schematic diagram schematically showing another configuration example of the migration plan display screen;

FIG. 8 is a schematic diagram schematically showing another configuration example of the migration plan display screen;

FIG. 9 is a schematic diagram schematically showing another configuration example of the migration plan display screen;

FIG. 10 is a schematic diagram schematically showing a configuration example of a first history display screen;

FIG. 11 is a schematic diagram schematically showing a configuration example of a second history display screen;

FIG. 12 is a schematic diagram schematically showing a configuration example of a migration schedule screen;

FIG. 13 is a conceptual diagram showing the configuration of an application/file system relationship table;

FIG. 14 is a conceptual diagram showing the configuration of a file system/logical device relationship table;

FIG. 15 is a conceptual diagram showing the configuration of a file system/VM volume relationship table;

FIG. 16 is a conceptual diagram showing the configuration of a VM volume/device group relationship table;

FIG. 17 is a conceptual diagram showing the configuration of a device group/logical device relationship table;

FIG. 18 is a conceptual diagram showing the configuration of a logical device/logical volume relationship table;

FIG. 19 is a conceptual diagram showing the configuration of a logical volume table;

FIG. 20 is a conceptual diagram showing the configuration of a compound logical volume/element logical volume relationship table;

FIG. 21 is a conceptual diagram showing the configuration of a virtual logical volume/pool relationship table;

FIG. 22 is a conceptual diagram showing the configuration of a pool table;

FIG. 23 is a conceptual diagram showing the configuration of a file system statistical information table;

FIG. 24 is a conceptual diagram showing the configuration of a virtual logical volume statistical information table;

FIG. 25 is a conceptual diagram showing the configuration of a pool statistical information table;

FIG. 26 is a conceptual diagram showing the configuration of a selection prioritization condition table;

FIG. 27 is a conceptual diagram showing the configuration of a file system/virtual logical volume correspondence table;

FIG. 28 is a conceptual diagram showing the configuration of a file system migration control table;

FIG. 29 is a conceptual diagram showing the configuration of an application execution schedule table;

FIG. 30 is a conceptual diagram showing the configuration of a file system usage schedule table;

FIG. 31 is a conceptual diagram showing the configuration of a file system migration schedule table;

FIG. 32 is a flowchart showing a processing routine of file system/virtual logical volume correspondence search processing;

FIG. 33 is a flowchart showing a processing routine of migration candidate selection prioritization processing;

FIG. 34 is a flowchart showing a processing routine of periodicity check processing;

FIG. 35 is a flowchart showing a processing routine of pool unused capacity check processing;

FIG. 36 is a flowchart showing a processing routine of file system usage schedule table creation processing;

FIG. 37 is a flowchart showing a processing routine of file system migration schedule table creation processing; and

FIG. 38 is a flowchart showing a processing routine of file system migration processing.

### DETAILED DESCRIPTION

An embodiment of the present invention is now explained in detail with reference to the attached drawings.

### (1) Configuration of Computer System in Present Embodiment

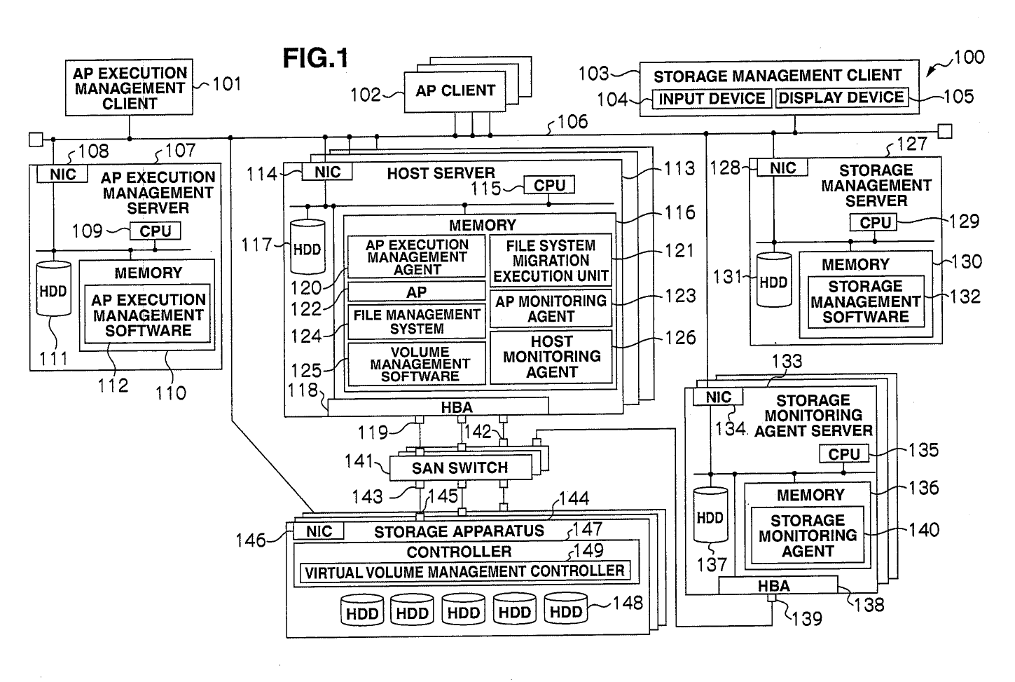

FIG. 1 shows the overall computer system 100 according to the present embodiment. This computer system 100 comprises a business system unit for performing processing concerning business in a SAN (Storage Area Network) environment, a business management system unit for managing the business system, and a storage management system unit for managing the storage of the SAN environment.

The business system unit comprises, as hardware, one or more application (AP: Applications) clients 102, a LAN (Local Area Network) 106, one or more host servers 113, one or more SAN switches 141, and one or more storage apparatuses 144, and comprises, as software, an application 122, a file management system 124 and a volume management software 125 which are respectively loaded in the host server.

The application client 102 is configured from an apparatus such as a personal computer, a workstation, a thin client terminal or the like that provides a user interface function of the business system unit. The application client 102 communicates with the application 122 or the like of the host server 133 via the LAN 106.

The host server 113 comprises a CPU (Central Processing Unit) 115, a memory 116, a hard disk device 117, a network interface card (NIC: Network Interface Card) 114, and a host bus adapter 118.

The CPU 115 is a processing for reading the various software programs stored in the hard disk device 117 into the memory 116, and executing such software programs. In the ensuing explanation, the processing to be executed by the software programs read into the memory 116 is actually executed by the CPU 115 that executes such software programs.

The memory 116, for example, is configured from a semiconductor memory such as a DRAM (Dynamic Random Access Memory). The memory 116 stores software programs to be read from the hard disk device 117 and executed by the CPU 115, data to be referred to by the CPU 115, and so on. Specifically, the memory 116 stores at least software programs including an application execution management agent 120, a file system migration execution unit 121, an application 122, an application monitoring agent 123, a file management system 124, a volume management software 125, and a host monitoring agent 126.

The hard disk device 117 is used for storing the various types of software and data. In substitute for the hard disk device 117, for example, a semiconductor memory such as a flash memory, an optical disk device or the like may be used.

The NIC 114 is used for the host server 113 to communicate with the application client 102, the storage management server 127 and the application execution management server 107 via the LAN 106.

The host bus adapter 118 is used for the host server 113 to communicate with the storage apparatus 144 via the SAN switch 141. The host bus adapter 118 comprises a port 119 as a connection terminal of a communication cable. Although the data I/O from the host server 113 to the storage apparatus 144 is performed according to a fibre channel (FC) protocol in this embodiment, the data I/O may also be performed according to a different protocol. Communication between the host server 113 and the storage apparatus 144 may be performed via the NIC 114 and the LAN 106 in substitute for the host bus adapter 118 and the SAN switch 141.

The SAN switches 141 respective comprise one or more host-side ports 142 and a storage-side port 143, and the data access path between the host server 113 and the storage apparatus 144 by switching the connection between these host-side ports 142 and the storage-side port 143.

The storage apparatus 144 is equipped with the AOU function, and comprises one or more ports 145, an NIC 146, a controller 147, and a plurality of hard disk devices.

The port 145 is used for communicating with the host server 113 or the storage monitoring agent server 133 via the SAN switch 141, and the NIC 146 is used for communicating with the storage management server 127 via the LAN 106. The communication path formed with the SAN switch 141 and the LAN 106 can also adopt a configuration of substituting one with the other.

The controller 147 comprises hardware resources such as a processor, a memory and the like, and controls the operation of the storage apparatus 144. For example, the controller 147 controls the writing and reading of data into and from the hard disk device 148 according to a request received from the host server 113. The controller 147 also includes at least a virtual volume management controller 149.

The virtual volume management controller 149 includes a function for providing a pool volume storage area to the host server 113 as the virtual logical volume. The virtual volume management controller 149 may also be realized by a processor not shown in the controller 147 executing the software programs stored in a memory not shown of the controller 147.

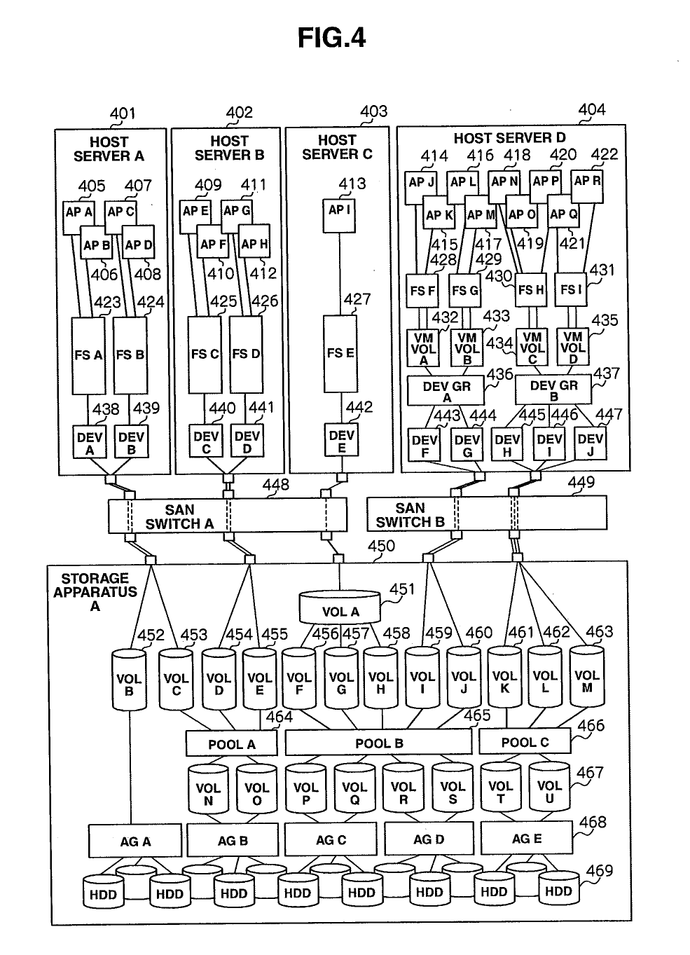

The hard disk device 148, for example, is configured from an expensive disk such as a SCSI (Small Computer System Interface) disk, or an inexpensive disk such as a SATA (Serial AT Attachment) disk or an optical disk. The controller 147 sets a real logical volume and a pool volume in the plurality of hard disk devices 148. The relationship of the hard disk device 148, the real logical volume and the pool volume will be described later (refer to FIG. 4).

Although FIG. 1 explains a case of adopting a configuration where the virtual volume management controller 149 is built into the controller 147 of the storage apparatus 144, it is also possible to adopt a configuration where the virtual volume management controller 149 is operated in a server that is independent from the storage apparatus 144.

The application 122 is configured from software for providing the business logical function of the business system, or database (DB) management software. The application 122 executes the input and output of data to and from the storage apparatus 144 as necessary in response to the processing request from the business client 102.

Access of data from the application 122 to the storage apparatus 144 is executed via the file management system 124, the volume management software 125, the port 119 of the host bus adapter 118, the host-side port 142 of the SAN switch 141, the SAN switch 141, the storage-side port 143 of the SAN switch 141, and the port 145 of the storage apparatus 144.

The file management system 124 is a part of the basic software (OS: Operating System) of the host server 113, and provides the storage area to become the data I/O destination in file units to the application 122. The files managed by the file management system 124 are associated, in units of a certain group (hereinafter referred to as a “file system”), with the VM volumes managed with the volume management software 125 described later or the logical devices managed with the OS by way of mounting operations or the like. Many of the files in the file system are managed in a tree structure.

The volume management software 125 provides the storage areas provided as a logical device by the OS to the file management system 124 in VM volume units upon consolidating and re-partitioning such storage areas. One or more logical devices may be defined as a single device group, and one device group can be partitioned to define one or more VM volumes.

Meanwhile, the business management system unit comprises, as hardware, an application execution management client 101 and an application execution management server 107, and comprises, as software, application execution management software 112, and an application execution management agent 120 loaded in the host server 113.

The application execution management client 101 is an apparatus for providing the user interface function of the application execution management software 112. The application execution management client 101 communicates with the application execution management software 112 of the application execution management server 107 via the LAN 106.

The application execution management server 107 comprises a CPU 109, a memory 110, a hard disk device 111, and an NIC 108. The CPU 109 is a processor for reading the software programs stored in the hard disk device 111 into the memory 110, and executing such software programs. In the ensuing explanation, the processing to be executed by the software programs read into the memory 110 is actually executed by the CPU 109 that executes such software programs.

The memory 110, for example, is configured from a semiconductor memory such as a DRAM. The memory 110 stores software programs to be read from the hard disk device 111 and executed by the CPU 109, data to be referred to by the CPU 109, and so on. Specifically, the CPU 109 executes at least the application execution management software 112.

The hard disk device 111 is used for storing the various types of software and data. In substitute for the hard disk device 111, for example, a semiconductor memory such as a flash memory, an optical disk device or the like may be used.

The NIC 108 is used for the application execution management server 107 to communicate with the application execution management client 101, the host server 113, and the storage management server 127 via the LAN 106.

The application execution management software 112 is software for providing a function for managing the execution and control of the application 122 in the host server 113. The application execution management agent 120 loaded in the host server 113 is used to start, execute and stop the application 122 according to a schedule defined by the user.

The application execution management agent 120 communicates with the application execution management software 112 in the application execution management server 107, and starts, executes and stops the application 122 according to the received instructions.

Meanwhile, the storage management system unit comprises, as hardware, a storage management client 103, a storage management server 127, and one or more storage monitoring agent servers 133, and comprises, as software, storage management software 132 loaded in the storage management server 127, an storage monitoring agent 140 loaded in the storage monitoring agent server 133, and a file system migration execution unit 121, an application monitoring agent 123 and a host monitoring agent 126 loaded respectively in the host server.

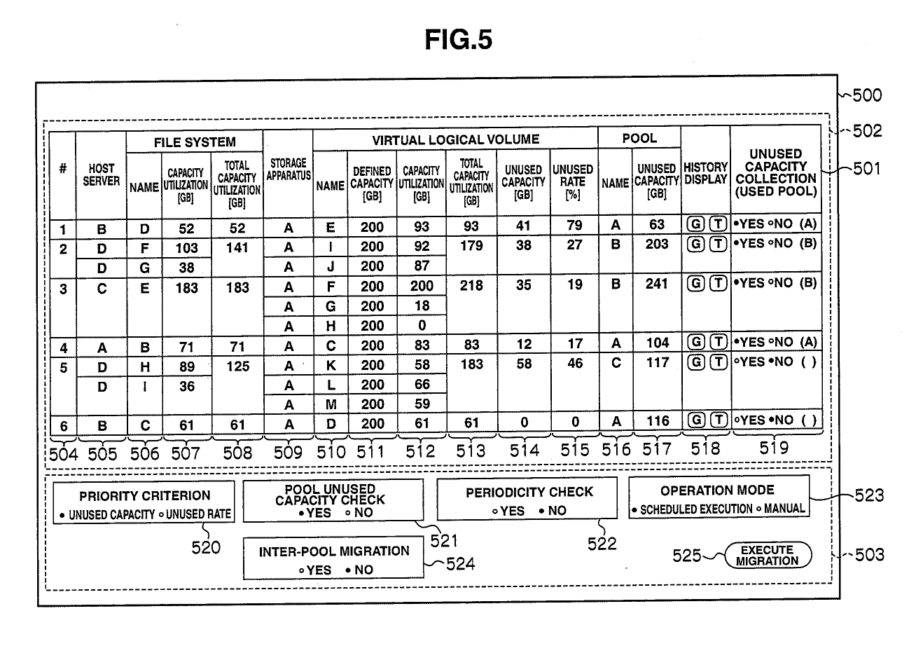

The storage management client 103 is an apparatus for providing the user interface function of the storage management software 132. The storage management client 103 at least comprises an input device 104 for receiving inputs from the user, and a display device 105 for displaying information to the user. The display device 105, for example, is an image display device such as a CRT or a liquid crystal display device. Examples of screens to be displayed on the display device 105 will be described later (FIG. 5 to FIG. 12). The storage management client 103 communicates with the storage management software 132 of the storage management server 127 via the LAN 106.

The storage management server 127 comprises a CPU 129, a memory 130, a hard disk device 131, and an NIC 128.

The CPU 129 is a processor for reading the software programs stored in the hard disk device 131 into the memory 130, and executing such software programs. In the ensuing explanation, the processing to be executed by the software programs read into the memory 130 is actually executed by the CPU 129 that executes such software programs.

The memory 130, for example, is configured from a semiconductor memory such as a DRAM. The memory 130 stores software programs to be read from the hard disk device 111 and executed by the CPU 129, data to be referred to by the CPU 129, and so on. Specifically, the memory 140 stores at least the storage management software 132.

The hard disk device 131 is used for storing the various types of software and data. In substitute for the hard disk device 131, for example, a semiconductor memory such as a flash memory, an optical disk device or the like may be used.

The NIC 128 is used for the storage management server 127 to communicate with the storage management client 103, the storage monitoring agent server 133, the host server 113, the storage apparatus 146 and the application execution management server 107 via the LAN 106. Communication between the storage management server 127 and the storage apparatus 144 can also adopt a configuration of providing a host bus adapter (not shown) and going through the SAN switch 141.

The storage monitoring agent server 133 comprises a CPU 135, a memory 136, a hard disk device 137, an NIC 134, a host bus adapter 138.

The CPU 135 is a processor for reading the software programs stored in the hard disk device 137 into the memory 136, and executing such software programs. In the ensuing explanation, the processing to be executed by the software programs read into the memory 136 is actually executed by the CPU 135 that executes such software programs.

The memory 136, for example, is configured from a semiconductor memory such as a DRAM. The memory 136 stores software programs to be read from the hard disk device 137 and executed by the CPU 135, data to be referred to by the CPU 135, and so on. Specifically, the memory 136 stores at least the storage monitoring agent 140.

The hard disk device 137 is used for storing the various types of software and data. In substitute for the hard disk device 137, for example, a semiconductor memory such as a flash memory, an optical disk device or the like may be used.

The NIC 134 is used for the storage monitoring agent server 133 to communicate with the storage management server 127 via the LAN 106. The host bus adapter 138 is used for the storage monitoring agent server 133 to communicate with the storage apparatus 144 via the SAN switch 141. The host bus adapter 138 comprises a port 139 as a connection terminal of a communication cable. Communication between the storage monitoring agent server 133 and the storage apparatus 144 may be performed via the NIC 134 and the LAN 106 in substitute for the host bus adapter 138 and the SAN switch 141.

The storage management software 132 is software for providing the function of collecting and monitoring SAN configuration information, statistical information and application execution management information, and detecting and collecting the unused area of the virtual logical volume with the file system. The storage management software 132 each uses dedicated agent software and application execution management software for acquiring configuration information, statistical information and application execution management information from the hardware and software configuring the SAN. In addition, the storage management software 132 uses the file system migration execution unit 121 for recovering the unused area of the virtual logical volume with the file system. Various methods may be adopted for the configuration and arrangement of the agent software and application execution management software, and an example thereof is explained below.

The storage monitoring agent 140 is software for acquiring configuration information and statistical information concerning the storage apparatus 145 via the port 139 of the host bus adapter 138 and the SAN switch 141. Although FIG. 1 illustrates a configuration where the storage monitoring agent 140 is operated with a dedicated storage monitoring agent server 133, it is also possible to adopt a configuration of operating the storage monitoring agent 140 in the storage management server 127. Further, as the communication path with the storage apparatus 145, it is also possible to adopt a configuration of using a path that passes through the NIC 134, the LAN 106 and the NIC 146 in substitute for passing through the host bus adapter 138, the SAN switch 141 and the port 145.

The application monitoring agent 123 is software for acquiring configuration information concerning the application 122. The host monitoring agent 126 is software for acquiring configuration information and statistical information concerning the file system from the file management system 124 and the volume management software 125.

The file system migration execution unit 121 communicates with the storage management software 132 in the storage management server 127, and performs processing of migrating data of the file system (hereinafter simply referred to as “migrating the file system”) according to the received instructions.

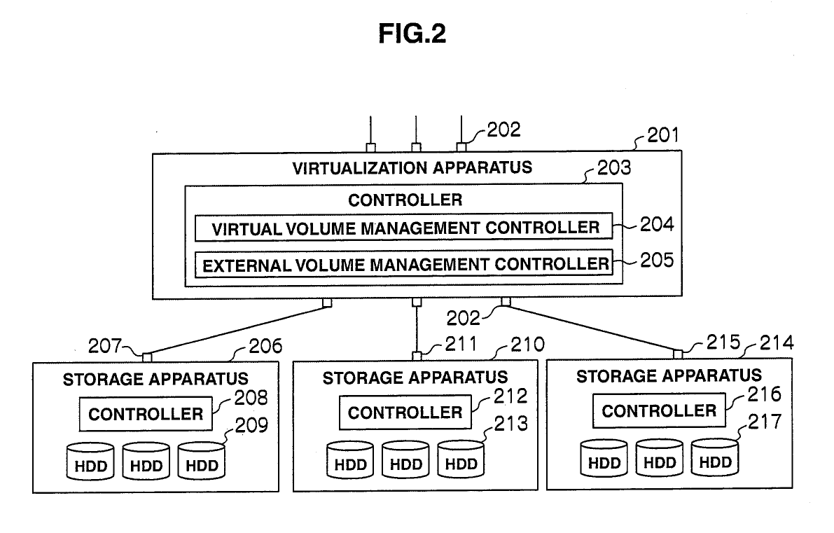

FIG. 2 shows a configuration example of a storage system to be applied in substitute for a part or the entirety of the storage apparatus 144 of FIG. 1. The storage system has a hierarchical structure configured from a virtualization apparatus 201, and a plurality of storage apparatuses 206, 210, 214.

The virtualization apparatus 201 comprises a port 202 for communicating with the host server 113 or the storage monitoring agent server 133 via the SAN switch 141, one or more ports 202 for communicating with the storage apparatuses 206, 210, 214, a controller 203 governing the operational control of the overall virtualization apparatus 201, and one or more hard disk devices (not shown).

The controller 203 comprises hardware resources including a processor, memory and the like. The controller 203 includes at least a virtual volume management controller 204 and an external volume management controller 205.

The virtual volume management controller 204 includes a function for providing a pool volume storage area set in the self apparatus to the host server 113 as the virtual logical volume. The external volume management controller 205 includes a function for providing a real logical volume set in the storage apparatuses 206, 210, 214 to the host server 113 as the real logical volume or the pool volume in the self apparatus. The virtual volume management controller 204 and the external volume management controller 205 may also be realized by a processor not shown in the controller 203 executing the software programs stored in a memory not shown of the controller 203.

The storage apparatuses 206, 210, 214 respectively comprise one or more ports 207, 211, 215 for communicating with the virtualization apparatus 201, controllers 208, 212, 216 for governing the operational control of the overall self apparatus, and a plurality of hard disk devices 209, 213, 216.

The controllers 208, 212, 216 comprise hardware resources including a processor, a memory and the like, and controls the writing and reading of data into and from the hard disk devices 209, 213, 216 according to a request given from the host server 113 via the virtualization apparatus 201.

The hard disk devices 209, 213, 216, for instance, are configured from expensive disks such as SCSI disks or inexpensive disks such as SATA disks or optical disks.. The controllers 208, 212, 216 set a real logical volume in the plurality of hard disk devices 209, 213, 216.

### (2) Configuration of Storage Management Software

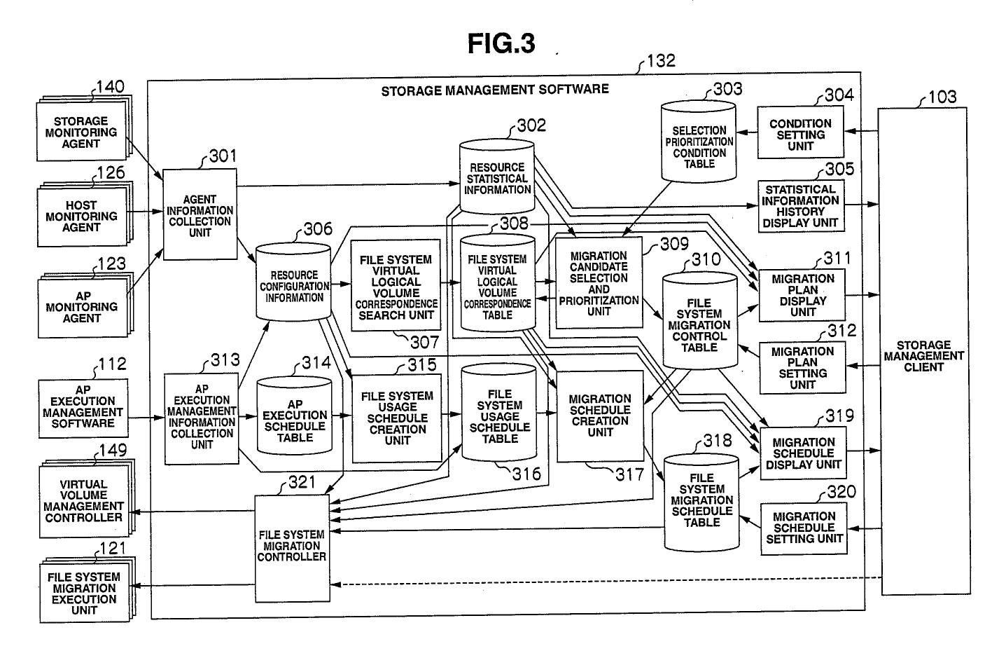

FIG. 3 shows a specific configuration of the storage management software 132. In FIG. 3, an agent information collection unit 301, a condition setting unit 304, a statistical information history display unit 305, a file system/virtual logical volume correspondence search unit 307, a migration candidate selection prioritization unit 309, a migration plan display unit 311, a migration plan setting unit 312, an application execution management information collection unit 313, a file system usage schedule creation unit 315, a migration schedule creation unit 317, a migration schedule display unit 319, a migration schedule setting unit 320, and a file system migration controller 321 are program modules configuring the storage management software 132.

Moreover, in FIG. 3, a resource statistical information 302, an selection prioritization condition table 303, a resource configuration information 306, a file system/virtual logical volume correspondence table 308, a file system migration control table 310, an application execution schedule table 314, a file system usage schedule table 316, and a file system migration schedule table 318 are various types of information managed by the storage management software 132, and retained in the memory 130 or the hard disk device 131.

In the foregoing storage management system unit, the collection and monitoring of configuration information, statistical information and application execution management information concerning the SAN environment are performed as follows.

The application monitoring agent 123 and the host monitoring agent 126 loaded in the host server 113, and the storage monitoring agent 140 loaded in the storage monitoring agent server 133 are started at a prescribed timing (for instance, periodically with a timer according to the scheduling setting), or started based on the request of the storage management software 132, and acquire configuration information or statistical information from the monitoring target apparatus or software handled by the self agent.

The agent information collection unit 301 of the storage management software 132 is also similarly started at a prescribed timing (for instance, periodically according to the set schedule), and collects the acquired configuration information or statistical information from the respective application monitoring agents 123, the respective host monitoring agents 126, and the respective storage monitoring agents 140 in the SAN environment. Then, the agent information collection unit 301 stores the collected information as either the resource configuration information 306 or the resource statistical information 302 in the memory 130 or the hard disk device 131.

The application execution management information collection unit 313 of the storage management software 132 is also started at a prescribed timing (for instance, periodically according to the set schedule), and collects configuration information or execution management information concerning the application from the application execution management software 112 in the SAN environment. Then, the application execution management information collection unit 313 stores the collected information as either the resource configuration information 306 or the application execution schedule table 314 in the memory 130 or the hard disk device 131.

Here, a resource is a collective designation of the hardware (storage apparatus, host server, etc.) configuring the SAN and its physical or logical constituent elements (array group, logical volume, etc.), and the programs (business software, database management system, file management system, volume management software, etc.) executed in the hardware and its logical constituent elements (file system, logical device, etc.).

The resource configuration information 306 can be broadly classified into related information between resources and attribute information of individual resources. The former represents the dependence of the data I/O existing between resources. For example, if the data I/O order of resource A is to be converted into the data I/O order of resource B and processed, or if the processing capacity of resource B is to be used when the data I/O order of resource A is to be processed, data I/O dependence will exist between resource A and resource B.

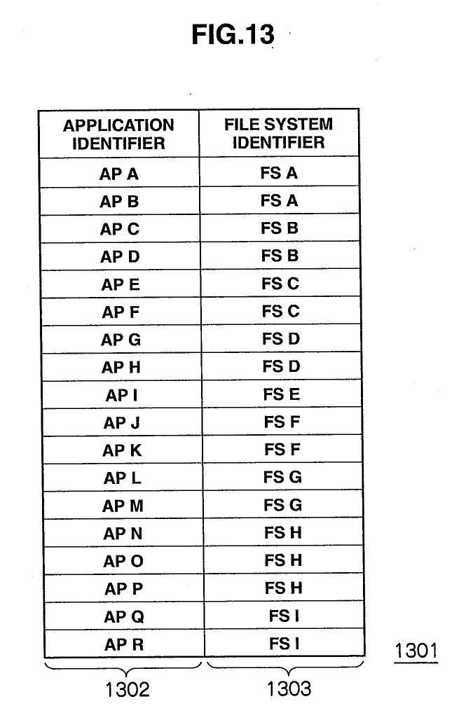

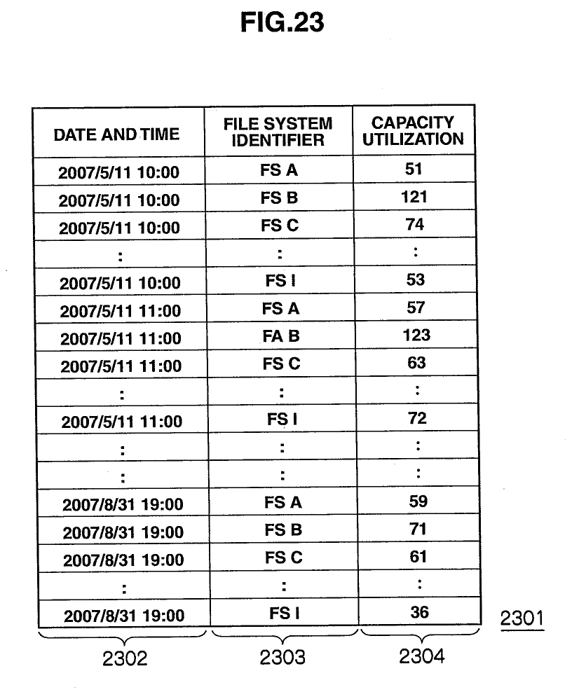

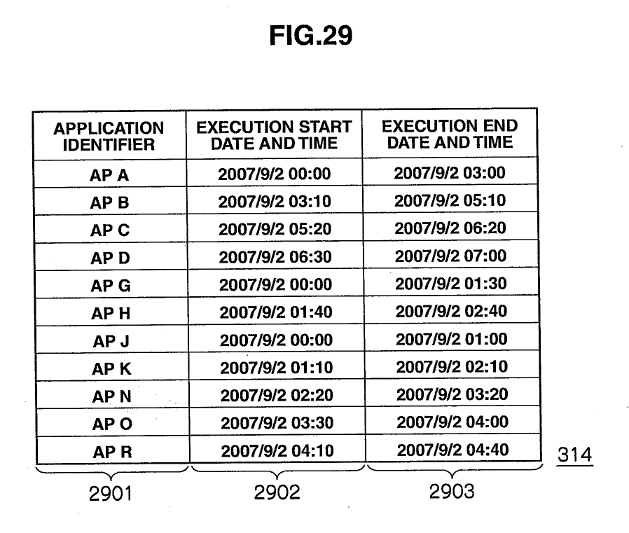

The table configuration and table configuration of the resource configuration information 306 will be explained in detail later with reference to FIG. 13 to FIG. 22. Moreover, the table configuration and table configuration of the resource statistical information 302 will be explained in detail later with reference to FIG. 23 to FIG. 25. In addition, the structure of the application execution schedule table 314 will be explained in detail later with reference to FIG. 29.

The detection and collection plan of the unused area of the virtual logical volume with the file system is created as follows.

The file system/virtual logical volume correspondence search unit 307 of the storage management software 132 is started at a prescribed timing (for instance, periodically according to the set schedule), or started unconditionally after the collection processing by the agent information collection unit 301, or started when there is any change to information concerning the file system and the virtual logical volume among the resource configuration information 306. When the file system/virtual logical volume correspondence search unit 307 is started, it checks the configuration information stored in the resource configuration information 306, and registers the file system and virtual logical volume group sharing the same data I/O path in the file system/virtual logical volume correspondence table 308.

The migration candidate selection prioritization unit 309 of the storage management software 132 may be started at a prescribed timing (for instance, periodically according to the set schedule), or started after the processing by the file system/virtual logical volume correspondence search unit 307, or started based on the request from the storage management client 103 triggered by the user's command operation.

When the migration candidate selection prioritization unit 309 is started, it selects and prioritizes the migration candidate regarding the pair of the file system and virtual logical volume stored in the file system/virtual logical volume correspondence table 308, and registers this result in the file system migration control table 310 as the file system migration plan.

During the selection and prioritization, the migration candidate selection prioritization unit 309 uses selection and prioritization conditions stored in the selection prioritization condition table 303, and the statistics stored in the resource statistical information 302. The selection and prioritization conditions in the selection prioritization condition table 303 are registered by the condition setting unit 304 based on the user's commands input from the input device 104 of the storage management client 103.

The migration plan display unit 311, the statistical information history display unit 305 and the migration plan setting unit 312 of the storage management software 132 are started based on the request from the storage management client 103 triggered by the user's command operation.

When the migration plan display unit 311 is started, it displays a list of the file system migration plans stored in the file system migration control table 310 on the display device 105 of the storage management client 103.

When the statistical information history display unit 305 is started, it displays the statistics history stored in the resource statistical information 302 on the display device 105 of the storage management client 103. When the migration plan setting unit 312 is started, is displays the migration plan display unit 311 on the display device 105 of the storage management client 103, and registers the file system migration plan revised or newly input by the user using the input device 105 of the storage management client 103 in the file system migration control table 310.

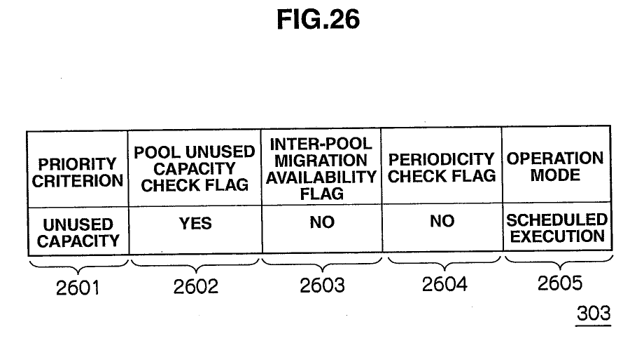

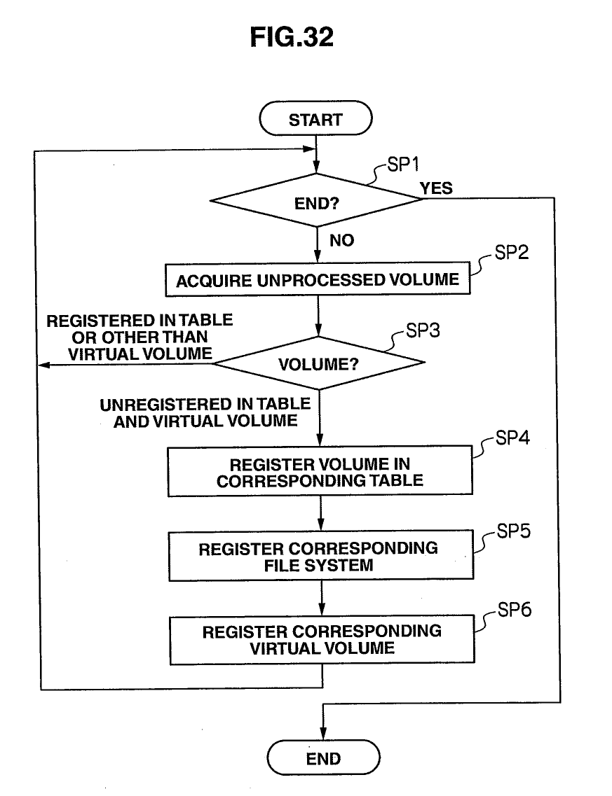

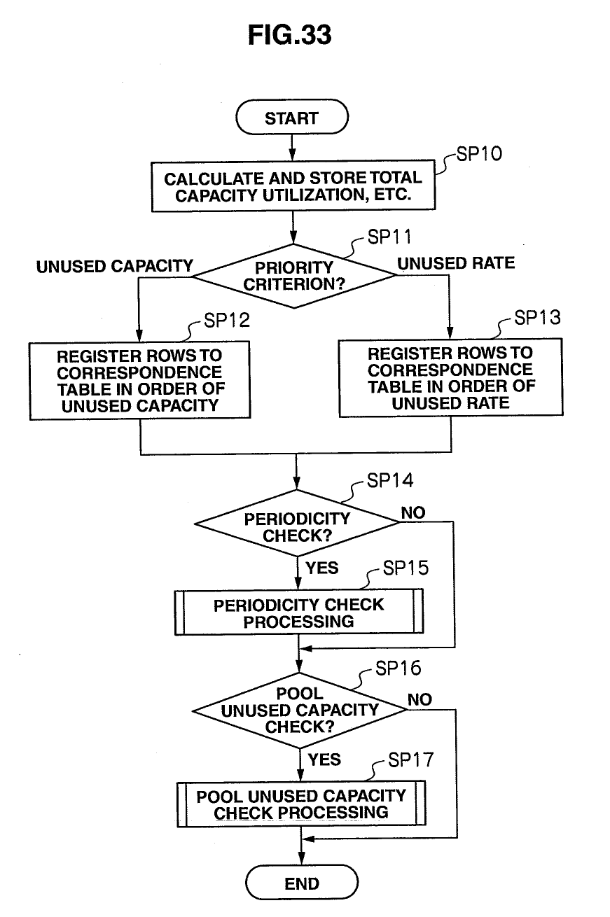

Specific examples of screens to be displayed on the storage management client 103 by the migration plan display unit 311 and the statistical information history display unit 305 will be explained later with reference to FIG. 5 to FIG. 11. Structures of the selection prioritization condition table 303, the file system/virtual logical volume correspondence table 308 and the file system migration control table 310 will be respectively explained in detail later with reference to FIG. 26 to FIG. 28. Details of the processing routine of the file system/virtual logical volume correspondence search unit 307 will be explained later with reference to FIG. 32. Details of the processing routine of the migration candidate selection prioritization unit 309 will be explained later with reference to FIG. 33 to FIG. 35.

Collection of the unused area of the virtual logical volume allocated to the file system is performed as follows.

If the operation mode of the storage management software 132 is “scheduled execution,” the file system usage schedule creation unit 315 of the storage management software 132 is started at a prescribed timing (for instance, periodically according to the set schedule), or started unconditionally after the collection processing by the agent information collection unit 301, or started when there is any change in information concerning the application and file system among the resource configuration information 306, and started after the collection processing by the application execution management information collection unit 313.

When the file system usage schedule creation unit 315 is started, it seeks the file system usage schedule based on the configuration information contained in the resource configuration information 306, and the application execution schedule stored in the application execution schedule table 314, and registers the result in the file system usage schedule table 316.

If the operation mode of the storage management software 132 is “scheduled execution,” the migration schedule creation unit 317 of the storage management software 132 is started at a prescribed timing (for instance, periodically according to the set schedule), or started after the processing by the migration candidate selection prioritization unit 309, or started based on the request from the storage management client 103 triggered by the user's command operation.

The migration schedule creation unit 317 seeks the file system migration schedule based on the statistics stored in the resource statistical information 302, correspondence information stored in the file system/virtual logical volume correspondence table 308, the migration plan stored in the file system migration control table 310, and the file system usage schedule stored in the file system usage schedule table 316, and registers the result in the file system migration schedule table 318.

The migration schedule display unit 319 and the migration schedule setting unit 320 of the storage management software 132 are started based on the request from the storage management client 103 triggered by the user's command operation.

When the migration schedule display unit 319 is started, it displays the file system migration schedule stored in the file system migration schedule table 318 on the display device 105 of the storage management client 103.

Further, when the migration schedule setting unit 320 is started, it displays the migration schedule display unit 319 on the display device 105 of the storage management client 103, and registers the file system migration schedule revised by the user using the input device 105 of the storage management client 103 in the file system migration schedule table 318.

If the operation mode of the storage management software 132 is “scheduled execution,” the file system migration controller 321 of the storage management software 132 is started at a prescribed timing (for instance, periodically according to the set schedule), and, if the operation mode of the storage management software 132 is “manual,” is started based on the requested from the storage management client 103 triggered by the user's command operation.

When the file system migration controller 321 is started, it issues a command necessary for migrating the file system to the virtual volume management controller 149 of the storage apparatus 144 and the file system migration execution unit 121 of the host server 113 based on the statistics stored in the resource statistical information 302, configuration information stored in the resource configuration information 306, configuration information stored in the file system/virtual logical volume correspondence table 308, the migration plan stored in the file system migration control table 310, and the schedule stored in the file system migration schedule table 318.

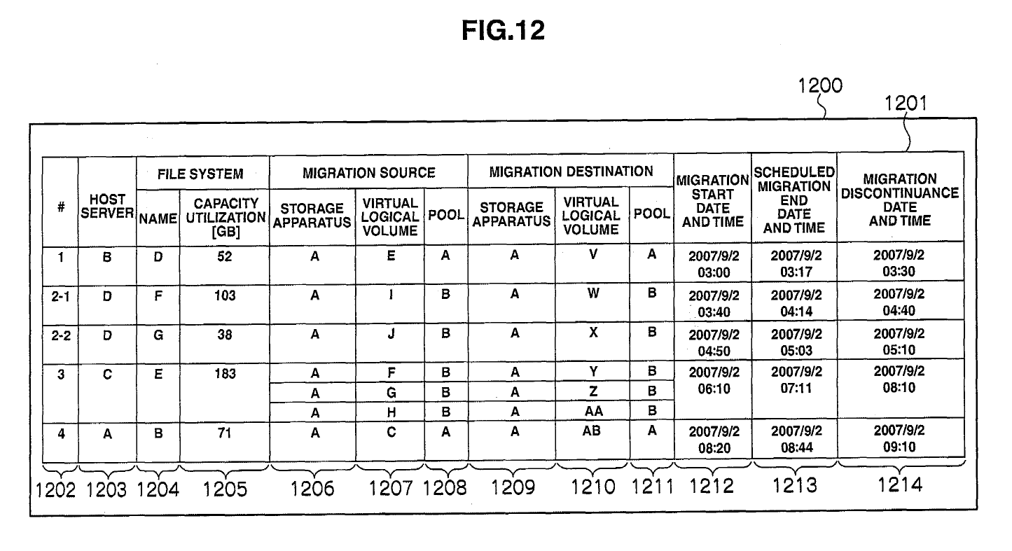

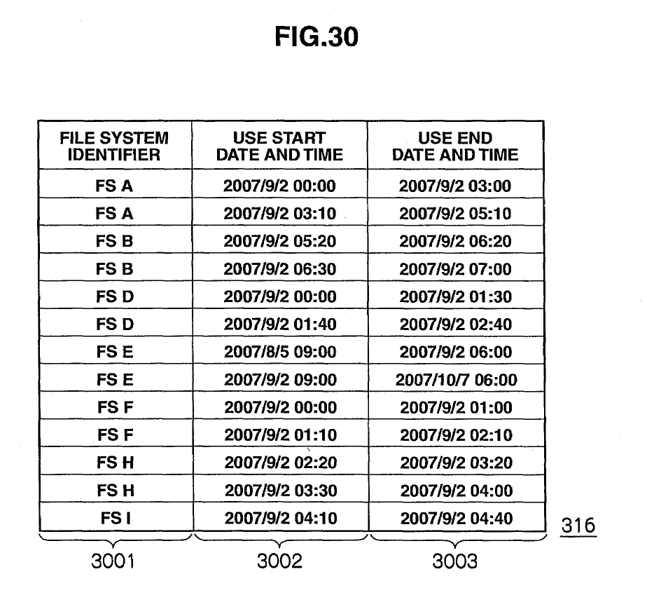

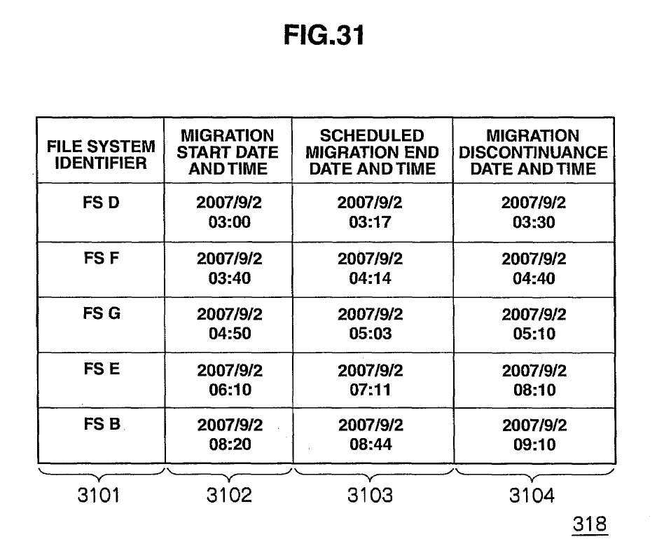

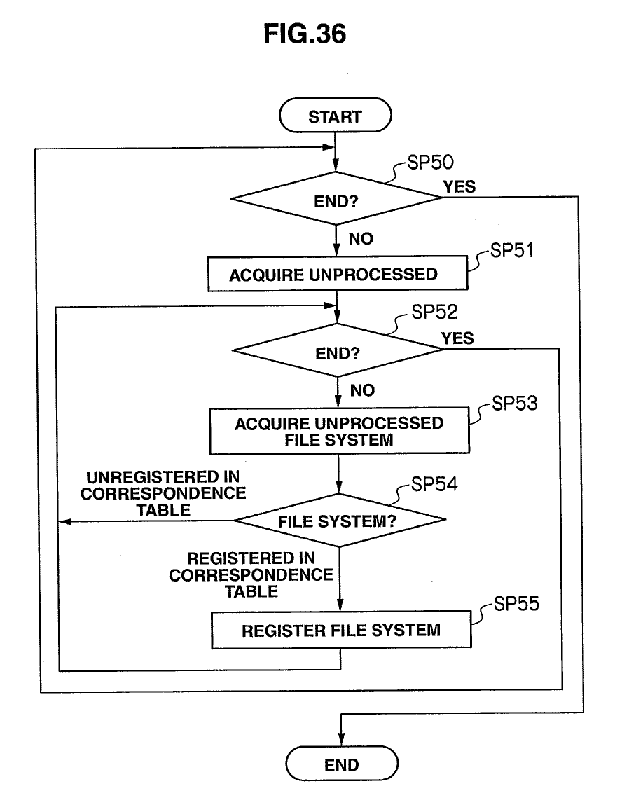

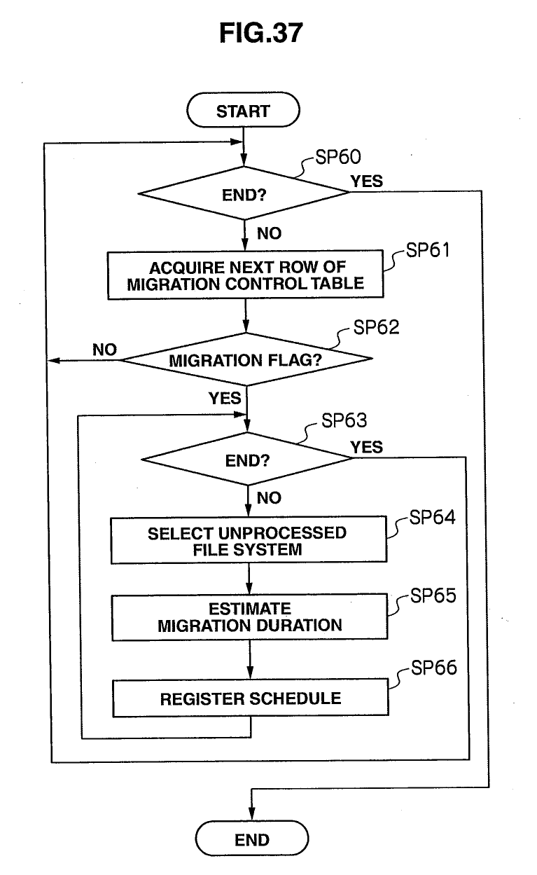

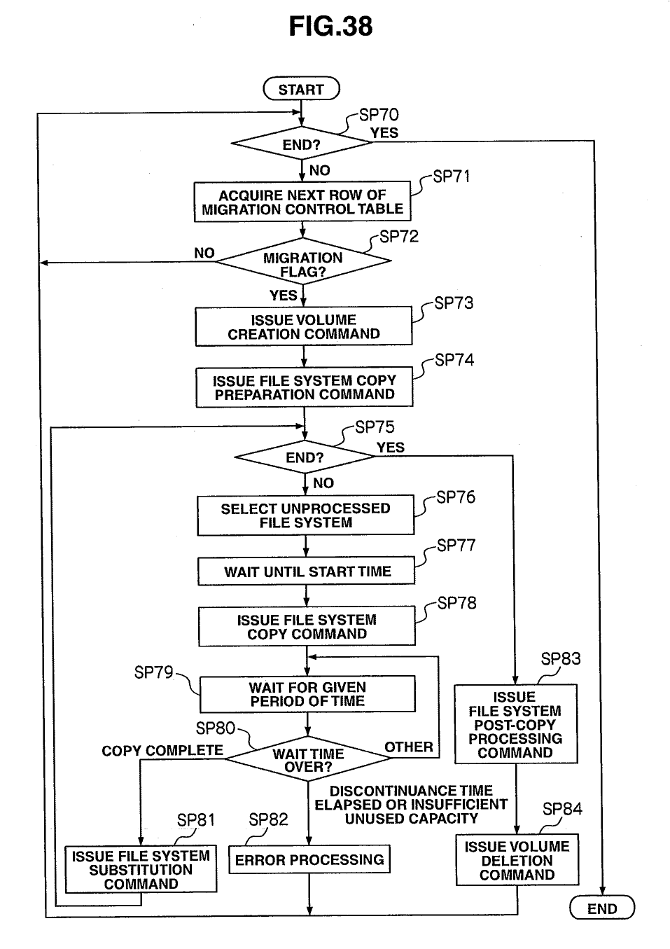

A specific example of a screen to be displayed by the migration schedule display unit 319 on the storage management client 103 will be explained later with reference to FIG. 12. A specific example of the structures of the file system usage schedule table 316 and the file system migration schedule table 318 will be explained later with reference to FIG. 30 and FIG. 31. Moreover, details of the processing routine of the file system usage schedule creation unit 315 will be explained later with reference to FIG. 36, and details of the processing routine of the migration schedule creation unit 317 will be explained later with reference to FIG. 37. Details of the processing routine of the file system migration controller 321 will be explained later with reference to FIG. 38.

### (3) Configuration of Resources and Relationship Between Resources

FIG. 4 shows specific examples of the configuration of resources and the relationship between resources in the SAN environment according to the present embodiment.

The hardware of the SAN environment illustrated in FIG. 4 is configured from four host servers 401 to 404 indicated as “host server A” to “host server D,” two SAN switches 448, 449 indicated as “SAN switch A” and “SAN switch B,” and one storage apparatus 450 indicated as “storage apparatus A.”

The host servers 401 to 404 are respectively one of the host servers 113 shown in FIG. 1. The SAN switches 448, 449 are respectively one of the SAN switches 141 shown in FIG. 1. The storage apparatus 450 is one of the storage apparatuses 144 shown in FIG. 1.

In the host servers 401 to 404, applications 405 to 408, 409 to 412, 413, 414 to 422 indicated as “AP_A” to “AP_D,” “AP_E” to “AP_H,” “AP_I” and “AP_J” to “AP_R” are operating, respectively. The applications 405 to 422 are respectively one of the applications 122 shown in FIG. 1.

In the host server 401 to host server 404, the application monitoring agent 123 for acquiring configuration information of the applications 405 to 422, and the host monitoring agent 126 for acquiring configuration information and statistical information concerning the file management system 124 and the volume management software 125 are operating.

File systems 423 to 431 indicated as “FS_A” to “FS_I,” VM volumes 432 to 435 indicated as “VM_VOL_A” to “VM_VOL_D,” device groups 436, 437 indicated as “DEV_GR_A” and “DEV_GR_B,” and logical devices 438 to 447 indicated as “DEV_A” to “DEV_J” are examples of resources targeted by the host monitoring agent 126 for acquiring information. Each of these resources is a resource for systematically managing the storage area to become the data I/O destination, and the file systems 423 to 431 are respectively managed with the file management system 124, the VM volumes 432 to 435 and the device groups 436, 437 are managed with the volume management software 125, and the logical devices 438 to 447 are managed with the basic software (OS) of the host server 401 to 404, respectively.

FIG. 4 displays lines connecting the resources. These lines represent that there is data I/O dependence between the two resources connected with such lines. For example, FIG. 4 displays two lines respectively connecting the applications 405, 406 to the file system 423. These lines represent the relation of the applications 405, 406 issuing a data I/O request to the file system 423.

The line connecting the file system 423 and the logical device 438 represents the relation where the data I/O load in the file system 423 becomes the data reading or data writing of the logical device 438. Similarly, the data I/O request issued by the application 418 shows the relation of arriving at the logical devices 445 to 447 via the file system 430, the VM volume 434 and the device group 437.

Although omitted in FIG. 4, the storage monitoring agent 140 is operating in order to acquire configuration information and statistical information of the storage apparatus 450. Resources that are targeted by the storage monitoring agent 140 for information acquisition are at least a compound logical volume 451 indicated as “VOL_A,” a real logical volume 452 indicated as “VOL_B,” virtual logical volumes 453 to 463 indicated as “VOL_C” to “VOL_M,” pools 464 to 466 indicated as “POOL_A” to “POOL_C,” and a pool volume 467 indicated as “VOL_N” to “VOL_U.”

A plurality of array groups 468 indicated as “AG_A” to “AG_E” are high-speed and reliable logical disk drives created respectively from a plurality of hard disk devices 469 based on the function of the controller 147 in the storage apparatus 450. In substitute for the hard disk device 469, for example, a semiconductor storage apparatus such as a flash memory, an optical disk device or the like may be used.

The real logical volume 452 and the respective pool volumes 467 are logical disk drives of a size that matches the usage of the host server 401 and created by the function of the controller 147 in the storage apparatus 450 partitioning the array group. With the real logical volume 452 and the respective pool volumes 467, the storage area in the amount of the capacity defined at the time of creation is secured in the corresponding array group 468 in advance.

The respective virtual logical volumes 453 to 463 are also recognized as logical disk drives by the host server 401 based on the function of the virtual logical volume management controller 149 in the storage apparatus 450 as with the real logical volume 452.

Nevertheless, unlike the real logical volume 452, only the capacity is defined when the virtual logical volumes 453 to 463 are created, and the storage area in the amount of the defined capacity is not secured. Thereafter, when a write request is issued to the new address of the virtual logical volume 453 to 463, a required amount of the storage area is allocated.

The pools 464 to 466 are used for allocating the storage area to the virtual logical volumes 453 to 463. The pool 464 is configured from two pool volumes 467 indicated as “VOL_N” and “VOL_O,” the pool 465 is configured from a plurality of pool volumes 467 indicated as “VOL_P” to “VOL_S,” and the pool 466 is configured from two pool volumes 467 indicated as “VOL_T” and “VOL_U,” respectively.

The compound volume is a logical disk drive created from a plurality of virtual logical volumes or a real logical volume based on the function of the controller 147 in the storage apparatus 450. The compound volume 451 is configured from the virtual logical volumes 456 to 458. The host server 403 recognizes the compound volume 451 as a single logical disk drive.

The logical devices 438 to 447 of each host server 401 to host server 404 are respectively allocated to the logical volumes (i.e., real logical volumes, virtual logical volumes or compound logical volumes) of the storage apparatus 450. The correspondence of the logical device and the logical volume can be acquired from the host monitoring agent 126.

As described above, when the related information between resources from the application that sequentially passes through the file system, the VM volume, the device group, the logical device, and eventually reaches the logical volume is combined, a so-called data I/O path is obtained.

For example, the application 413 issues a data I/O request to the file system 427, the file system 427 is secured in the logical device 442, the logical device 442 is allocated to the compound logical volume 451, the compound logical volume 451 is configured from the virtual logical volumes 456 to 458, the virtual logical volumes 456 to 458 are allocated to the pool 465, the pool 465 is configured from the pool volumes 467 indicated as “VOL_P” to “VOL_S,” the pool volumes 467 indicated as “VOL_P” and “VOL_Q” are allocated to the array group 468 indicated as “AG_C,” and the pool volumes 467 indicated as “VOL_R” and “VOL_S” are allocated to the array group 468 indicated as “AG_D,” respectively. In the foregoing case, the load of the data I/O request issued by the application 413 passes a path from the file system 427 through the logical device 442, the compound logical volume 451, the virtual logical volumes 456 to 458, the pool 465, the pool volumes indicated as “VOL_P” to “VOL_S” and the array groups indicated as “AG_C” and “AG_D,” and eventually arrives at the hard disk device 469.

### (4) Configuration of Various Screens

(4-1) Configuration of Migration Plan Display Screen

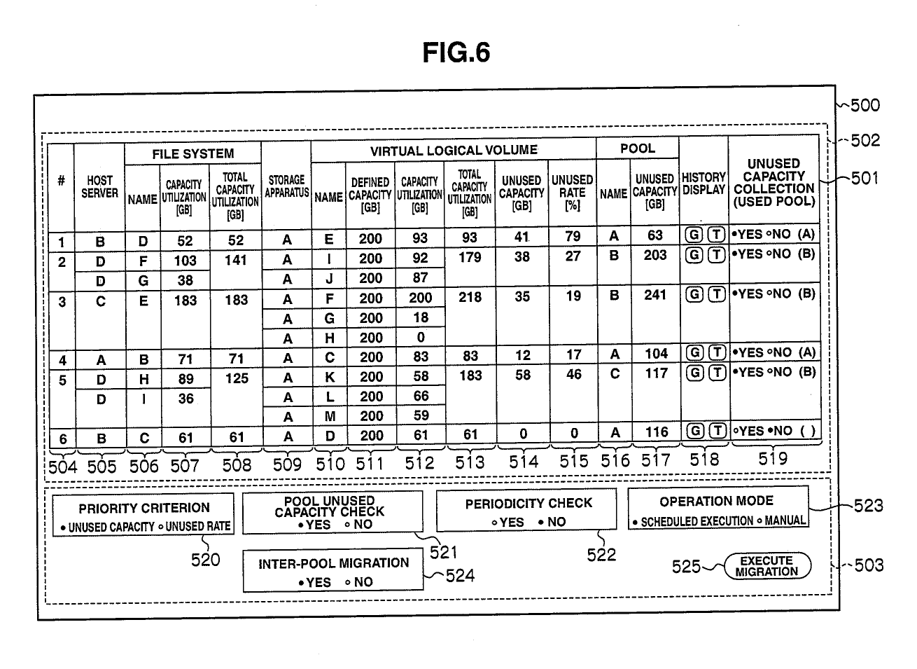

An example of a GUI (Graphical User Interface) screen to be displayed on the migration plan display unit 311 is now explained with reference to FIG. 5 and FIG. 6. Specifically, FIG. 5 and 6 are examples of the GUI screen to be displayed on the display device 105 of the storage management client 103 according to commands from the migration plan display unit 311.

FIG. 5 shows an example of the migration plan display screen 500 to be displayed by the migration plan display unit 311 when the user sets the inter-pool migration condition to “YES.” The migration plan display screen 500 is configured from a migration plan list table display area 502 for displaying the migration plan list table of the file system (hereinafter referred to as a “migration plan list table”) 501, and a condition display area 503 for displaying the selection and prioritization conditions of the migration plan.

The migration plan list table 501 is configured from a migration priority display column 504, a host server display column 505, a file system name display column 506, a file system capacity utilization display column 507, a file system total capacity utilization display column 508, a storage apparatus display column 509, a virtual logical volume name display column 510, a virtual logical volume defined capacity display column 511, a virtual logical volume capacity utilization display column 512, a virtual logical volume total capacity utilization display column 513, a virtual logical volume unused capacity display column 514, a virtual logical volume unused ratio display column 515, a pool name display column 516, a pool unused capacity display column 517, a history display column 518, and an unused capacity collection column 519. The respective rows of the migration plan list table 501 correspond to one group pair of the file system and the virtual logical volume specified by the file system/virtual logical volume correspondence search unit 307 of the storage management software 132, and correspond to one of the rows of the file system/virtual logical volume correspondence table 308 and the file system migration control table 310, respectively.

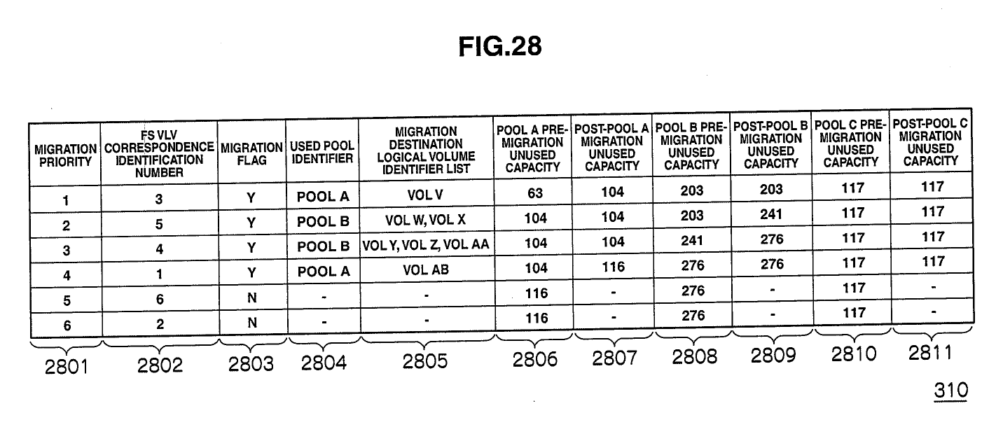

The migration priority display column 504 displays the priority of the migration plan that was decided by the migration candidate selection prioritization unit 309. This priority is read from the migration priority storage column 2801 of the file system migration control table 310 (FIG. 28) described later.

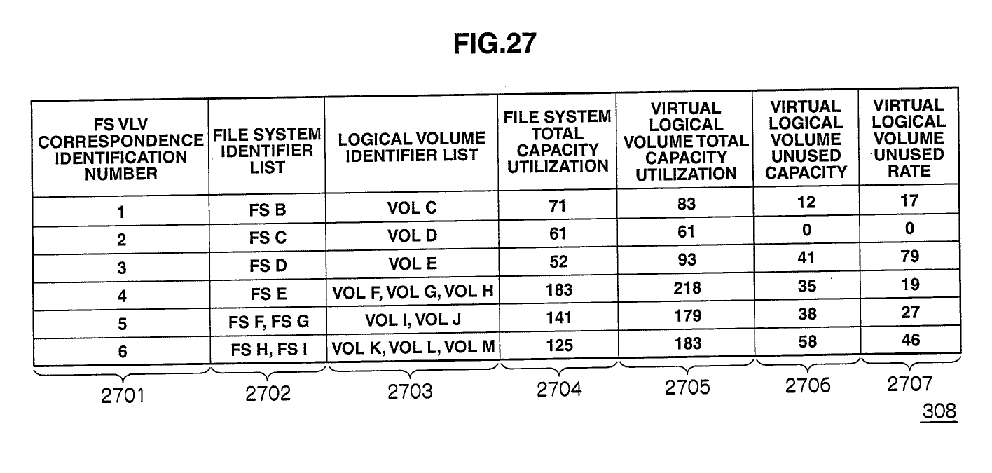

The host server display column 505 displays the name of the host server storing the file system to be migrated in the migration plan shown in that row. The name of the host server is specified from the identifier of the corresponding file system stored in the file system identifier list storage column 2702 of the file system/virtual logical volume correspondence table 308 (FIG. 27) described later. For example, this identifier is configured from information (for instance, an IP address or a host name) for uniquely identifying the host server storing the file system and information (for instance, path to the mount point of the file system) for uniquely identifying the file system in the foregoing host server, and the former is used to specify the name of the host server.

The file system name display column 506 displays the name of the file system to be migrated in the migration plan shown in that row. The name of the file system is specified from the identifier stored in the file system identifier list storage column 2702 (FIG. 27) of the file system/virtual logical volume correspondence table 308 (FIG. 27) described later. For example, as described above, this identifier is configured from information (for instance, an IP address or a host name) for uniquely identifying the host server storing the file system and information (for instance, path to the mount point of the file system) for uniquely identifying the file system in the foregoing host server, and the latter is used to specify the name of the file system.

The file system capacity utilization display column 507 displays the capacity utilization for each file system to be migrated in the migration plan shown in that row. The capacity utilization value of each file system is read from the capacity utilization storage column 2304 of the row in which the date and time storage column 2302 (FIG. 23) is latest among the rows searched from the file system statistical information table 2301 (FIG. 23) described later with the identifier of the corresponding file system stored in the file system identifier list storage column 2702 (FIG. 27) of the file system/virtual logical volume correspondence table 308 (FIG. 27) described later as the search key.

The file system total capacity utilization display column 508 displays the total capacity utilization of the file system group to be migrated in the migration plan shown in that row. The total capacity utilization value of the file system is read from the file system total capacity utilization storage column 2704 of the file system/virtual logical volume correspondence table 308 (FIG. 27) described later.

The storage apparatus display column 509 displays the name of the storage apparatus storing the virtual logical volume corresponding to the file system to be migrated in the migration plan shown in that row. The name of the storage apparatus is specified from the identifier of the corresponding logical volume stored in the logical volume identifier list storage column 2703 of the file system/virtual logical volume correspondence table 308 (FIG. 27) described later. For example, this identifier is configured from information (for instance, a model number or a serial number of the apparatus) for uniquely identifying the storage apparatus storing the logical volume and information for uniquely identifying the logical volume in the foregoing storage apparatus, and the former is used to specify the name of the storage apparatus.

The virtual logical volume name display column 510 displays the name of the virtual logical volume corresponding to the file system to be migrated in the migration plan shown in that row. The name of the virtual logical volume is specified from the identifier of the corresponding logical volume stored in the logical volume identifier list storage column 2703 (FIG. 27) of the file system/virtual logical volume correspondence table 308 (FIG. 27) described later. For example, this identifier is configured from information (for instance, a model number or a serial number of the apparatus) for uniquely identifying the storage apparatus storing the logical volume and information for uniquely identifying the logical volume in the foregoing storage apparatus, and the latter is used to specify the name of the virtual logical volume.

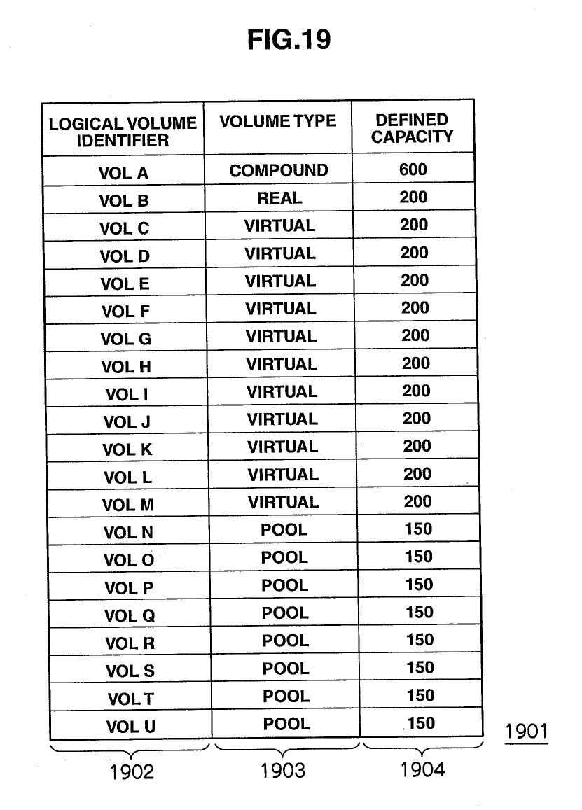

The virtual logical volume defined capacity display column 511 displays the defined capacity of the virtual logical volume corresponding to the file system to be migrated in the migration plan shown in that row. The defined capacity value of the virtual logical volume is read from the defined capacity storage column 1904 (FIG. 19) of the row searched from the logical volume table 1901 (FIG. 19) described later with the identifier stored in the logical volume identifier list storage column 2703 (FIG. 27) of the file system/virtual logical volume correspondence table 308 (FIG. 27) described later as the search key.

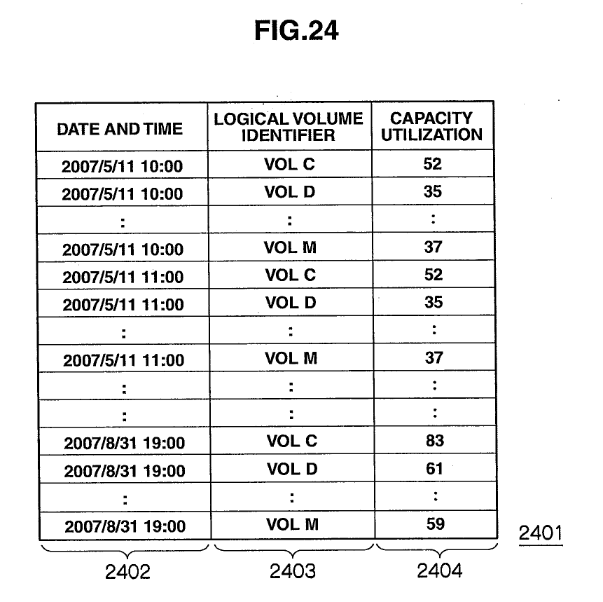

The virtual logical volume capacity utilization display column 512 displays the capacity utilization for reach virtual logical volume corresponding to the file system to be migrated in the migration plan shown in that row. The capacity utilization value of each virtual logical volume is read from the capacity utilization storage column 2404 (FIG. 24) of the row in which the date and time storage column 2402 is latest among the rows searched from the virtual logical volume statistical information table 2401 (FIG. 24) described later with the identifier stored in the logical volume identifier list storage column 2703 (FIG. 27) of the file system/virtual logical volume correspondence table 308 (FIG. 27) described later as the search key.

The virtual logical volume total capacity utilization display column 513 displays the total capacity utilization of the virtual logical volume group corresponding to the file system to be migrated in the migration plan shown in that row. The total capacity utilization value of the virtual logical volume is read from the virtual logical volume total capacity utilization storage column 2705 (FIG. 27) of the file system/virtual logical volume correspondence table 308 (FIG. 27) described later.

The virtual logical volume unused capacity display column 514 displays the unused capacity of the virtual logical volume group corresponding to the file system to be migrated in the migration plan shown in that row. The unused capacity value of the virtual logical volume is read from the virtual logical volume unused capacity storage column 2706 (FIG. 27) of the file system/virtual logical volume correspondence table 308 (FIG. 27) described later.

The virtual logical volume unused ratio display column 515 displays the unused ratio of the virtual logical volume group corresponding to the file system to be migrated in the migration plan shown in that row. The unused ratio value of the virtual logical volume is read from the virtual logical volume unused ratio storage column 2707 (FIG. 27) of the file system/virtual logical volume correspondence table 308 (FIG. 27) described later.

The pool name display column 516 displays the name of the pool allocated with the virtual logical volume corresponding to the file system to be migrated in the migration plan shown in that row. The name of the pool is specified from the identifier of the corresponding pool stored in the pool identifier storage column 2103 of the row searched from the virtual logical volume/pool relationship table 2101 (FIG. 21) described later with the identifier stored in the logical volume identifier list storage column 2703 (FIG. 27) of the file system/virtual logical volume correspondence table 308 (FIG. 27) described later as the search key. For example, this identifier is configured from information (for instance, a model number or a serial number of the apparatus) for uniquely identifying the storage apparatus storing the pool and information for uniquely identifying the pool in the foregoing storage apparatus, and the latter is used to specify the name of the pool.

The pool unused capacity display column 517 displays the unused capacity of the pool allocated with the virtual logical volume corresponding to the file system to be migrated in the migration plan shown in that row. The unused capacity of the pool is read from the column concerning the corresponding pool among the POOL_A pre-migration pool unused capacity storage column 2806 (FIG. 28), the POOL_B pre-migration pool unused capacity storage column 2808 (FIG. 28) and the POOL_C pre-migration pool unused capacity storage column 2810 (FIG. 28) of the row searched from the file system migration control table 310 (FIG. 28) described later with the FS/VLV correspondence ID number stored in the FS/VLV correspondence ID number storage column 2701 (FIG. 27) of the file system/virtual logical volume correspondence table 308 (FIG. 27) described later as the search key.

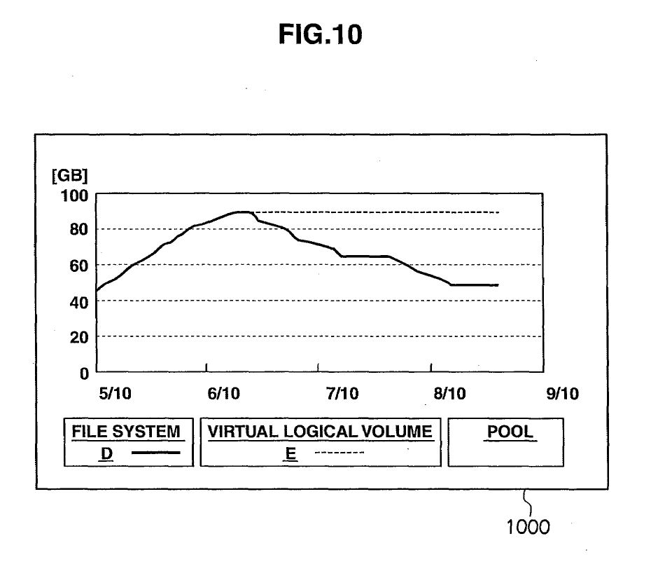

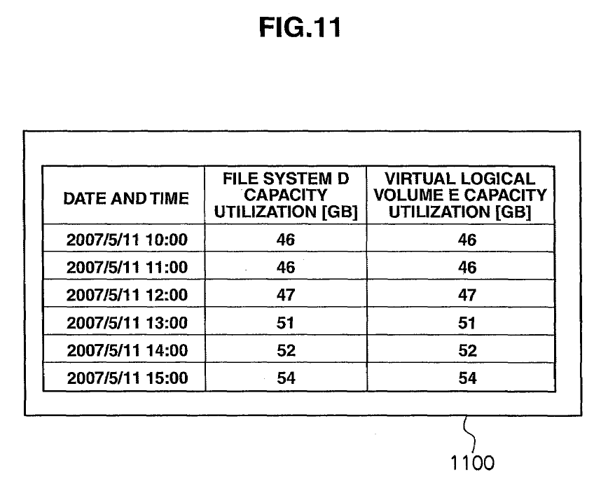

The history display column 518 displays the buttons to be used by the user for commanding the display of the history of the file system to be migrated in the migration plan shown in that row and the capacity utilization history of the virtual logical volume corresponding to the file system. The buttons labeled “G” and “T” are for displaying the capacity utilization history in a graph format and a table format, respectively. The user is able to command the display of history by operating the buttons (specifically, for instance, by clicking the button with a mouse) using the input device 104 (FIG. 1) of the storage management client 103. Specific examples of screens to be used upon displaying the capacity utilization history of the file system and the virtual logical volume in a graph format or a table format will be explained later with reference to FIG. 10 and FIG. 11, respectively.

The unused capacity collection column 519 displays the selection status of whether to migrate the file system according to the migration plan shown in that row. Specifically, between the options of “YES (migrate)” and “NO (do not migrate),” the selected option is displayed as a black circle. When the option (“YES) of migrating the file system is being selected, the name of the pool to be used as the migration destination is displayed on the unused capacity collection column 519. The selection status of the file system migration is read from the migration flag storage column 2803 (FIG. 28) of the file system/virtual logical volume correspondence table 308 (FIG. 27) described later, and the value of the name of the pool to be used at such time is identified from the identifier stored in the used pool identifier storage column 2804 (FIG. 28) of the file system/virtual logical volume correspondence table 308. For example, this identifier is configured from information (for instance, a model number or a serial number of the apparatus) for uniquely identifying the storage apparatus storing the pool and information for uniquely identifying the pool in the foregoing storage apparatus, and the latter is used to specify the name of the pool.

Accordingly, while referring to FIG. 4, FIG. 5 shows that the file system 426 indicated as “D” of the host server 402 indicated as “B” is ranked as the first migration priority, and the capacity utilization and total capacity utilization of the overall group thereof are both “52” GB. In addition, this file system is associated with the virtual logical volume 455 indicated as “E,” wherein the defined capacity is “200” GB, the capacity utilization and the total capacity utilization of the overall group are both “93” GB, the unused capacity is “41” GB, and the unused ratio is “79”%, which is set to the storage apparatus 450 having the name of “A,” and this virtual logical volume is allocated with the pool 464 indicated as “A” having an unused capacity of “63” GB. FIG. 5 also shows that the file system 426 indicated as “D” is a migration target, and the migration destination is the pool indicated as “A.”

FIG. 5 shows an example where the group of a plurality of files systems and the group of a plurality of virtual logical volumes are corresponding is ranked as the second migration priority in the second row of the migration plan list table 501, and the row for displaying the information concerning the plurality of files system and the virtual logical volume is partially segmentalized. In this example, the file system 428 indicated as “F” and the file system 429 indicated as “G” of the host server 404 indicated as “D” are migration targets, and the capacity utilization thereof is “103” GB and “38” GB, and the total capacity utilization of the overall group is “141” GB. The virtual logical volumes corresponding to the file systems 428, 429 are the virtual logical volume 459 indicated as “I” and the virtual logical volume 460 indicated as “J” provided in the storage apparatus 450 indicated as “A,” and the defined capacity is respectively “200” GB, the capacity utilization is respectively “92” GB and “87” GB, and the total capacity utilization of the overall group is “179” GB.

In FIG. 5, the unused capacity collection column 519 in the fifth and sixth rows of the migration plan list table 501 is set to “NO.” This represents that the file system group 430 indicated as “H” and the file system 431 indicated as “I” of the host server 404 indicated as “D,” and the file system 425 indicated as “C” of the host server 402 indicated as “B” are not migration targets. The reason why the file system 430 indicated as “H” and the file system 431 indicated as “I” are not migration targets is because, whereas the total capacity utilization of the file systems 430, 431 is “125” GB, since the unused capacity of the pool 466 indicated as “C” associated with the file systems 430, 431 is only “117” GB, the area for temporarily copying the data required for migration is insufficient. Further, the reason why the file system 425 indicated as “C” is not a migration target is because the capacity utilization of the file system 425 and the capacity utilization of the corresponding virtual logical volume 454 are both “61” GB, and the unused capacity is “0” GB.

Meanwhile, the condition display area 503 is provided with the respective columns of a priority criterion column 320, a pool unused capacity check column 521, a periodicity check column 522, an operation mode column 523 and an inter-pool migration column 524, and a “migration execution” button 525.

The priority criterion column 320 displays, as the criterion for the migration candidate selection prioritization unit 309 to elect and prioritize the migration plan, whether the “unused capacity” of the virtual logical volume calculated as the difference between the total capacity utilization of the corresponding virtual logical volume and the respective file systems, or the “unused ratio” calculated as the ratio of the unused capacity of the corresponding virtual logical volume and the total capacity utilization of the file system is selected. Specifically, a round black circle is displayed in the selected radio button between the radio associated with the “unused capacity” and the radio button associated with the “unused ratio.”

In the foregoing case, the user can switch the priority criterion using the input device 104 of the storage management client 103. Specifically, for instance, the user is able to input commands for switching the priority criterion by clicking the label of “unused capacity” or “unused ratio” with a mouse. Based on such user's command, the condition setting unit 304 registers the selected priority criterion in the priority criterion storage column 2601 (FIG. 26) of the selection prioritization condition table 303 (FIG. 26) described later.

The pool unused capacity check column 521 displays a selection status regarding the conditions of whether to check the unused capacity of the pool for temporarily storing data for copying data upon migrating the file system among the selection and prioritization conditions when the migration candidate selection prioritization unit 309 selects and prioritizes the migration plan. Specifically, a round black circle is displayed in the selected radio button between the radio associated with the “YES” as an option for performing the check and the radio button associated with the “NO” as an option for not performing the check.

In the foregoing case, the user is able to switch whether or not to perform the check using the input device 104 of the storage management client 103. Specifically, the user is able to input a command for switching whether or not to perform the check by clicking the label of “YES” or “NO” with a mouse. Based on the user's command, the condition setting unit 304 registers the status of check necessity in the pool unused capacity check flag storage column 2602 (FIG. 26) of the selection prioritization condition table 303 (FIG. 26) described later.

The periodicity check column 522 displays the selection status regarding the conditions of whether to check the temporal increase or decrease of the capacity utilization of the file system among the selection and prioritization conditions when the migration candidate selection prioritization unit 309 selects and prioritizes the migration plan. Specifically, a round black circle is displayed in the selected radio button between the radio associated with the “YES” as an option for performing the check and the radio button associated with the “NO” as an option for not performing the check.

In the foregoing case, the user can switch whether or not to perform the check using the input device 104 of the storage management client 103. Specifically, for example, the user is able to input a command for switching whether or not to perform the check by clicking the label of “YES” or “NO” with a mouse. Based on the user's command, the condition setting unit 304 registers the status of check necessity in the periodicity check flag storage column 2604 (FIG. 26) of the selection prioritization condition table 303 (FIG. 26) described later.

The operation mode column 523 displays the selected operation mode of the storage management software 132. Specifically, a round black circle is displayed in the selected radio button between the radio associated with the operation mode of “scheduled execution” and the radio button associated with the operation mode of “manual.”

In the foregoing case, the user can switch the operation mode using the input device 104 of the storage management client 103. Specifically, for example, the user is able to input a command for switching the operation mode by clicking the label of “scheduled execution” or “manual” with a mouse. Based on the user's command, the condition setting unit 304 (FIG. 3) registers the operation mode in the operation mode storage column 2605 (FIG. 26) of the selection prioritization condition table 303 (FIG. 26) described later.

The inter-pool migration column 524 displays the selection status regarding the conditions of whether to migrate the file system across different pools among the selection and prioritization conditions when the migration candidate selection prioritization unit 309 (FIG. 3) selects and prioritizes the migration plan. Specifically, a round black circle is displayed in the selected radio button between the radio associated with the “YES” as an option for performing the migration across different pools and the radio button associated with the “NO” as an option for not performing the migration across different pools.

In the foregoing case, the user can switch the selection of inter-pool migration availability using the input device 104 of the storage management client 103. Specifically, for example, the user is able to input a command for switching the status of inter-pool migration availability by clicking the label of “YES” or “NO” with a mouse. Based on the user's command, the condition setting unit 304 registers the status of inter-pool migration availability in the inter-pool migration availability flag storage column 2603 (FIG. 26) of the selection prioritization condition table 303 (FIG. 26) described later.

In the computer system 100, the file system migration processing is executed by being triggered by the user's command operation when the operation mode of the storage management software 132 is set to “manual,” and the “migration execution” button 525 is the button to be used for inputting such command operation. The user is able to start the file system migration controller 321 by operating the “migration execution” button 525 using the input device 104 of the storage management client 103 (specifically, for example, by clicking the button with a mouse).

Meanwhile, FIG. 6 shows an example of the updated migration plan display screen 500 to be displayed by the migration plan display unit 311 after the user changes the selection status of “NO” to “YES” of the inter-pool migration column 524 using the input device 104 of the storage management client 103 in the migration plan display screen 500 shown in FIG. 5.

The status of the inter-pool migration availability changed by the user is registered in the inter-pool migration availability flag storage column 2603 (FIG. 26) of the selection prioritization condition table 303 (FIG. 26) described later by the condition setting unit 304. Further, the migration candidate selection prioritization unit 309 started from the storage management client 103 triggered by the user's operation for changing the setting re-registers the result of re-executing the selection and prioritization of migration candidates of the changed election prioritization condition table 303 in the file system migration control table 310, and displays the changed migration plan registered in the migration plan display unit 311 on the display device 105 of the storage management client 103. FIG. 6 shows an example of the migration plan display screen 500 to be displayed in the foregoing case.

In FIG. 6, the changed migration plan list table 501 shows a status where “YES” is selected in the unused capacity collection column 519 of the fifth row. This represents that the file system group 430 indicated as “H” and the file system 431 indicated as “I” of the host server 404 indicated as “D,” which was not a migration target at the stage of FIG. 5, has changed to a migration target. This is because, although inter-pool migration was not possible when the total capacity utilization of these file systems 430, 431 was “125” GB and the unused capacity of the pool 466 indicated as “C” was only “117” GB, since the unused capacity of the pool 465 indicated as “B” is “276” GB, migration is enabled by using the pool 465 when inter-pool migration is allowed.

The unused capacity of “241” GB of the pool 465 indicated as “B” displayed in the pool unused capacity display column 517 of the third row of the migration plan list table 501 illustrated in FIG. 6 is a value before the migration of the file system 427 corresponding to the third row. Since the storage area in the amount of the unused “35” GB (=218 GB−183 GB) will be collected after the foregoing migration, the unused capacity of the pool 465 indicated as “B” will increase to 276 GB (=241 GB/+35 GB).

The unused capacity of the respective pools before and after the migration of the file system is calculated with the migration candidate selection prioritization unit 309, and stored in a POOL_A pre-migration pool unused capacity storage column 2806, a POOL_A post-migration pool unused capacity storage column 2807, a POOL_B pre-migration pool unused capacity storage column 2808, a POOL_B post-migration pool unused capacity storage column 2809, a POOL_C pre-migration pool unused capacity storage column 2810, and a POOL_C post-migration pool unused capacity storage column 2811 of the file system migration control table 310 (FIG. 28) described later. In FIG. 28, for example, the unused capacity of the pool 465 indicated as “B” is increased from “241” GB to “276” GB in the third row, this corresponds to the third row of the migration plan list table 501 in the migration plan display screen 500 of the FIG. 5 (and FIG. 6).

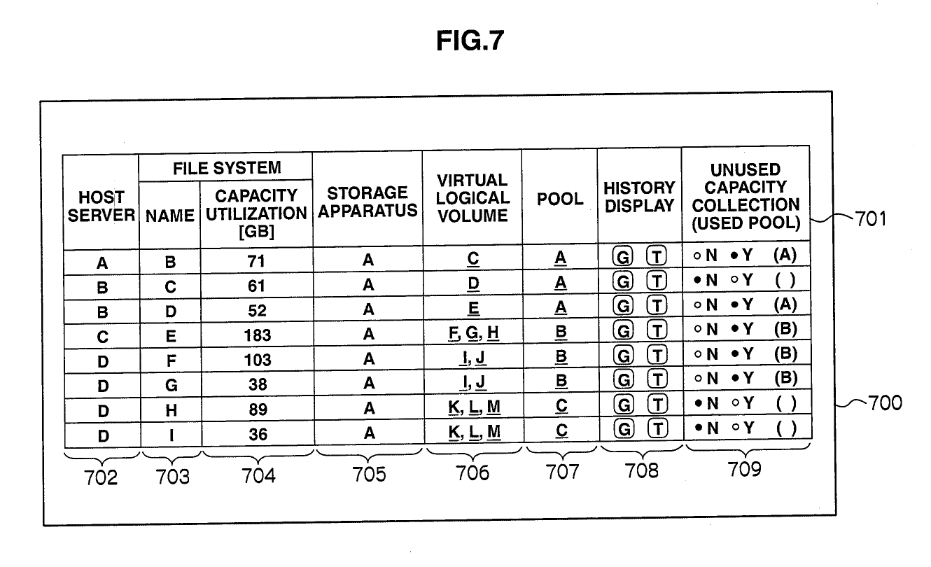

Another embodiment of the migration plan display screen 500 to be displayed by the migration plan display unit 311 is shown in FIG. 7 to FIG. 9.

FIG. 7 shows a migration plan display screen 700 for displaying a migration plan for each file system. The migration plan display screen 700 is configured from a migration plan list table 701. The migration plan list table 701 is configured from a host server display column 702, a file system name display column 703, a file system capacity utilization display column 704, a storage apparatus display column 705, a virtual logical volume display column 706, a pool display column 707, a history display column 708 and an unused capacity collection column 709.

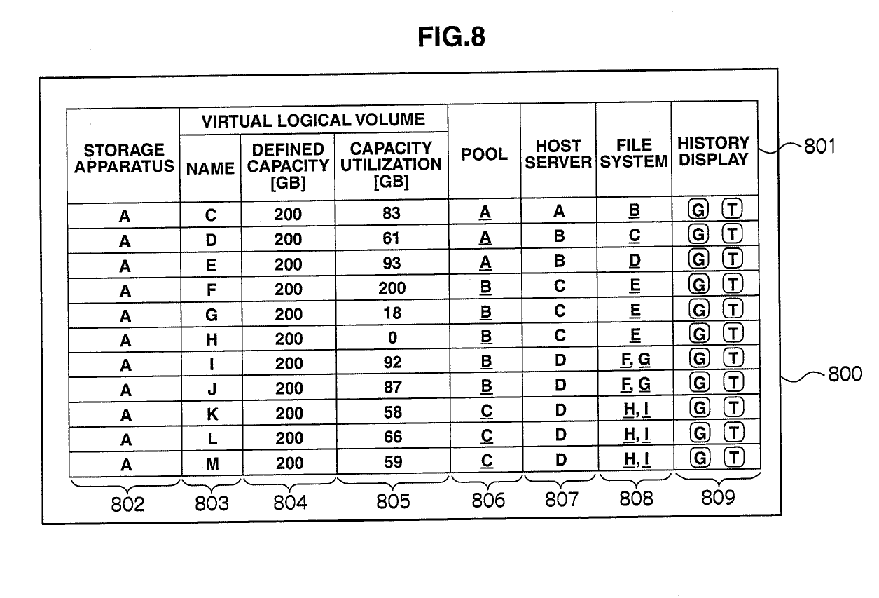

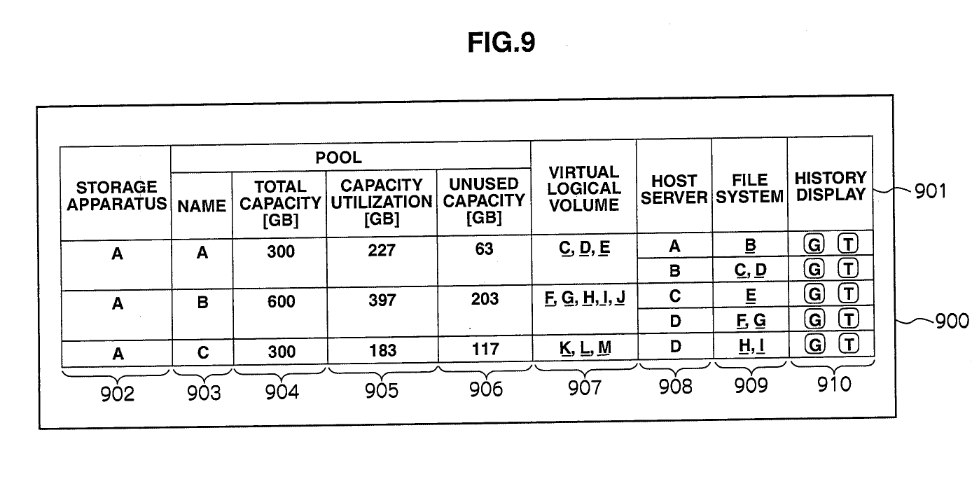

Among the above, the host server display column 702, the file system name display column 703, the file system capacity utilization display column 704, the storage apparatus display column 705, the pool display column 707, the history display column 708, and the unused capacity collection column 709 display the same information as the host server display column 505, the file system name display column 506, the file system capacity utilization display column 507, the storage apparatus display column 509, the pool name display column 516, the history display column 518 and the unused capacity collection column 519 of the migration plan list table 500 described with reference to FIG. 5. The virtual logical volume display column 706 also displays the name of all virtual logical volumes associated with the name of the file systems stored in the file system name column 703 of the same row. Further, the name of the virtual logical volume displayed on the virtual logical volume display column 706 and the name of the pool displayed on the pool display column 707 are respectively set with a hyperlink (displayed with an underline), and the user is able to command the display of the related screen and positioning of the input curser to the row displaying such information by operating the hyperlink by using the input device 104 (FIG. 1) of the storage management client 103. Specifically, for example, the user is able to command the display of the migration plan display screen 800 (FIG. 8) and the positioning of the input curser to the row displaying the virtual logical volume by clicking the location displaying the name of the virtual logical volume displayed in the virtual logical volume display column 706 with a mouse. Further, the user is able to command the display of the migration plan display screen 900 (FIG. 9) and positioning of the input curser to the row displaying the corresponding pool by clicking the location displaying the name of the pool displayed in the pool display column 707 with a mouse.

FIG. 8 shows a migration plan display screen 800 for displaying the migration plan for each virtual logical volume. The migration plan display screen 800 is configured from a migration plan list table 801. The migration plan list table 801 is configured from a storage apparatus display column 802, a virtual logical volume name display column 803, a virtual logical volume defined capacity display column 804, a virtual logical volume capacity utilization display column 805, a pool display column 806, a host server display column 807, a file system display column 808 and a history display column 809.

Among the above, the storage apparatus display column 802, the virtual logical volume name display column 803, the virtual logical volume defined capacity display column 804, the virtual logical volume capacity utilization display column 805, the pool display column 806, the host server display column 807 and the history display column 809 display the same information as the storage apparatus display column 509, the virtual logical volume name display column 510, the virtual logical volume defined capacity display column 511, the virtual logical volume capacity utilization display column 512, the pool name display column 516, the host server display column 505 and the history display column 518 of the migration plan list table 500 described with reference to FIG. 5. The file system display column 808 displays the name of all file systems corresponding to the name of the virtual logical volumes stored in the virtual logical volume name display column 803 of the same row. Further, the name of the pool displayed on the pool display column 806 and the name of the file system displayed on the file system display column 808 are respectively set with a hyperlink (displayed with an underline), and the user is able to command the display of the related screen and positioning of the input curser to the row displaying such information by operating the hyperlink by using the input device 104 (FIG. 1) of the storage management client 103. Specifically, for example, the user is able to command the display of the migration plan display screen 900 (FIG. 9) and the positioning of the input curser to the row displaying the pool by clicking the location displaying the name of the pool displayed in the pool display column 806 with a mouse. Further, the user is able to command the display of the migration plan display screen 700 (FIG. 7) and positioning of the input curser to the row displaying the corresponding file system by clicking the location displaying the name of the file system displayed in the file system display column 808 with a mouse.

The FIG. 9 shows a migration plan display screen 900 for displaying the migration plan for each pool. The migration plan display screen 900 is configured from only a migration plan list table 901. The migration plan list table 901 is configured from a storage apparatus display column 902, a pool name display column 903, a pool total capacity display column 904, a pool capacity utilization display column 905, a pool unused capacity display column 906, a virtual logical volume display column 907, a host server display column 908, a file system display column 909 and a history display column 910.

Among the above, the storage apparatus display column 902, the pool name display column 903, the pool total capacity display column 904, the pool capacity utilization display column 905, the pool unused capacity display column 906, the host server display column 908 and the history display column 910 display the same information as the storage apparatus display column 509, the pool name display column 516, the pool unused capacity display column 517, the host server display column 505 and the history display column 518 of the migration plan list table 500 described with reference to FIG. 5. The virtual logical volume display column 907 displays the name of all virtual logical volumes associated with the name of the pool stored in the pool name column 903 of the same row, and the file system column 909 displays the name of all file systems associated with such pools. Further, the name of the virtual logical volume displayed on the virtual logical volume display column 907 and the name of the file system displayed on the file system display column 909 are respectively set with a hyperlink (displayed with an underline), and the user is able to command the display of the related screen and positioning of the input curser to the row displaying such information by operating the hyperlink by using the input device 104 (FIG. 1) of the storage management client 103. Specifically, for example, the user is able to command the display of the migration plan display screen 800 (FIG. 8) and the positioning of the input curser to the row displaying the virtual logical volume by clicking the location displaying the name of the virtual logical volume displayed in the virtual logical volume display column 907 with a mouse. Further, the user is able to command the display of the migration plan display screen 700 (FIG. 7) and positioning of the input curser to the row displaying the corresponding file system by clicking the location displaying the name of the file system displayed in the file system display column 909 with a mouse.

The migration plan display screens 700, 800, 900 shown in FIG. 7 to FIG. 9 are to be separately displayed on the migration plan display unit 311, and the user is thereby able to plan a migration plan based on the file system, the virtual logical volume or the pool.

(4-2) Configuration of History Display Screen

An example of a screen to be displayed on the statistical information history display unit 305 is now explained with reference to FIG. 10 and FIG. 11. Specifically, FIG. 10 and FIG. 11 show screen examples to be displayed on the display device 105 of the storage management client 103 according to commands from the statistical information history display unit 305.

FIG. 10 shows an example of a first history display screen 1000 to be displayed overlappingly on the migration plan display screen 500 when the button labeled “G” displayed in the history display column 518 of the first row of the migration plan list table 501 is operated in the migration plan display screen 500 explained with reference to FIG. 5. The first history display screen 1000 displays, in graph format, the capacity utilization history of the utilization capacity of the file system indicated as “D” corresponding to the first row of the migration plan list table 501 and the virtual logical volume indicated as “E” corresponding to the file system. When the button labeled “G” displayed in the history display column 518 of the other rows of the migration plan list table 501 is operated, the capacity utilization history of the corresponding file system and virtual logical volume is similarly displayed in graph format.

FIG. 11 shows an example of a second history display screen 1100 to be displayed overlappingly on the migration plan display screen 500 when the button labeled “T” is displayed in the history display column 518 of the first row of the migration plan list table 501 in the migration plan display screen 500 explained with reference to FIG. 5. The second history display screen 1100 displays, in table format, the capacity utilization history of the utilization capacity of the file system indicated as “D” corresponding to the first row of the migration plan list table 501 and the virtual logical volume indicated as “E” corresponding to the file system. When the button labeled “T” displayed in the history display column 518 of the other rows of the migration plan list table 501 is operated, the capacity utilization history of the corresponding file system and virtual logical volume is similarly displayed in table format.

(4-3) Configuration of Migration Schedule Screen

An example of a screen to be displayed by the migration schedule display unit 319 is now explained with reference to FIG. 12. Specifically, FIG. 12 shows a configuration example of the migration schedule screen 1200 to be displayed on the display device 105 of the storage management client 103 according to commands from the migration schedule display unit 319.

The migration schedule screen 1200 displays a list of migration schedules of the respective migration target file systems stored in the file system migration schedule table 318 as a migration schedule list table 1201.

The migration schedule list table 1201 is configured from an execution sequence display column 1202, a host server display column 1203, a file system name display column 1204, a file system capacity utilization display column 1205, a migration source storage apparatus display column 1206, a migration source virtual logical volume display column 1207, a migration source pool display column 1208, a migration destination storage apparatus display column 1209, a migration destination virtual logical volume display column 1210, a migration destination pool display column 1211, a migration start date and time display column 1212, a scheduled migration end date and time display column 1213 and a migration discontinuance date and time display column 1214.

The execution sequence display column 1202 displays the execution sequence of the migration schedule shown in that row. The execution sequence is read from the migration priority storage column 2801 of the file system migration control table 310 (FIG. 28) described later, and then displayed. When identifiers of a plurality of files systems are stored in the file system identifier list storage column 2702 of the file system/virtual logical volume correspondence table 308 (FIG. 27) corresponding to the respective rows of the file system migration control table 310, branch numbers are added to the foregoing execution sequence and displayed.

The host server display column 1203 displays the name of the host server storing the migration target file system in the migration schedule shown in that row. The name of the host server is identified from the identifier of the corresponding file system stored in the file system identifier list storage column 2702 (FIG. 27) of the file system/virtual logical volume correspondence table 308 (FIG. 27) described later.

The file system name display column 1204 and the file system capacity utilization display column 1205 display the name and the current capacity utilization of the migration target file system in the migration schedule shown in that row. The name of the file system is identified from the identifier of the corresponding file system stored in the file system identifier list storage column 2702 (FIG. 27) of the file system/virtual logical volume correspondence table 308 (FIG. 27) described later. The file system capacity utilization is identified from the capacity utilization stored in the capacity utilization storage column 2304 (FIG. 23) of the file system statistical information table 2301 (FIG. 23) described later.

The migration source storage apparatus display column 1206, the migration source virtual logical volume display column 1207 and the migration source pool display column 1208 respectively display the name of the storage apparatus storing the migration target file system, the name of the virtual logical volume allocated with such file system, and the name of the pool associated with the virtual logical volume in the migration schedule shown in the respective rows. The foregoing information is identified from the logical volume stored in the logical volume identifier list storage column 2703 of the file system/virtual logical volume correspondence table 308 (FIG. 27) described later, or detected and displayed based on the search using the configuration information stored in the resource configuration information 306 based on the identifier.

The migration destination storage apparatus display column 1209, the migration destination virtual logical volume display column 1210 and the migration destination pool display column 1211 respectively display the name of the migration destination storage apparatus of the migration target file system, the name of the migration destination virtual logical volume of the file system, and the name of the pool associated with the virtual logical volume in the migration schedule shown in the respective rows. The foregoing information is identified from the identifiers stored in the corresponding migration destination logical volume identifier list storage column 2805 and the used pool identifier 2804 of the file system migration control table 310 (FIG. 28).

The migration start date and time display column 1212, the scheduled migration end date and time display column 1213 and the migration discontinuance date and time display column 1214 respectively display the date and time (migration start date and time) on which the migration of the migration target file system will be started, the date and time (scheduled migration end date and time) on which such migration is schedule to end, and the date and time on which migration is to be discontinued when the migration does not end on the scheduled migration end date and time in the migration schedule shown in the respective rows. As the foregoing dates and times, the dates and times respectively stored in the migration start date and time storage column 3102 (FIG. 31), the scheduled migration end date and time storage column 3103 (FIG. 31) and the migration discontinuance date and time storage column 3104 (FIG. 31) of the corresponding rows of the file system migration schedule 318 (FIG. 31) described later are read and displayed.

Accordingly, FIG. 12 shows that the file system in which the host server indicating as “B” having a capacity utilization indicated as “D” of “52” GB is the migration target, the identifiers of the migration source storage apparatus, the virtual logical volume and the pool are respectively “A,” “E” and “A,” the identifiers of the migration destination storage apparatus, the virtual logical volume and the pool are respectively “A,” “V” and “A,” the migration start date and time is 3:00 AM on Sep. 2, 2007 (“Sep. 2, 2007 03:00”), the scheduled migration end date and time is 3:17 AM on Sep. 2, 2007 (Sep. 2, 2007 03:17”), and the migration discontinuance date and time is 3:30 AM on Sep. 2, 2007 (“Sep. 2, 2007 03:30”).

### (5) Configuration of Various Types of Information and Tables

(5-1) Configuration of Resource Configuration Information

An example of the table configuration and table structure of the resource configuration information 306 to be used by the storage management software 132 is now explained with reference to FIG. 13 to FIG. 22.

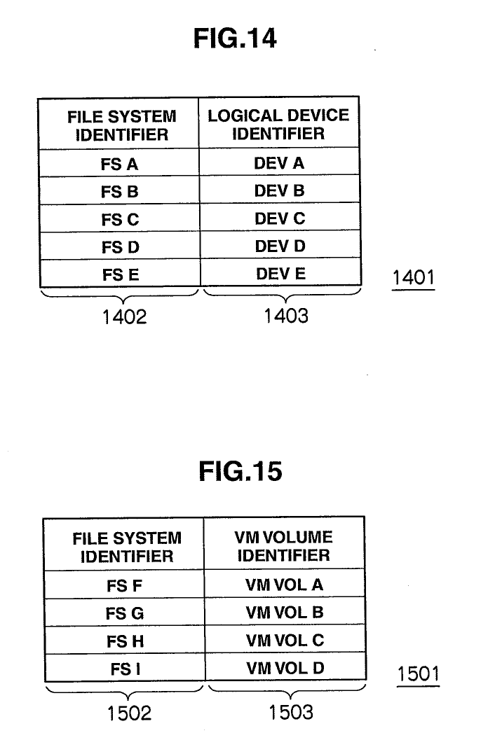

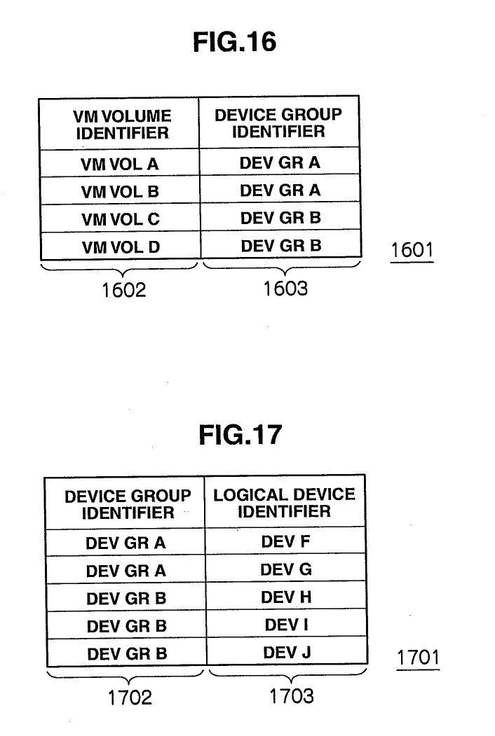

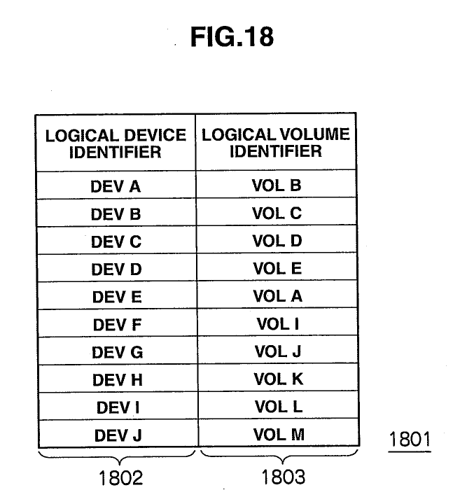

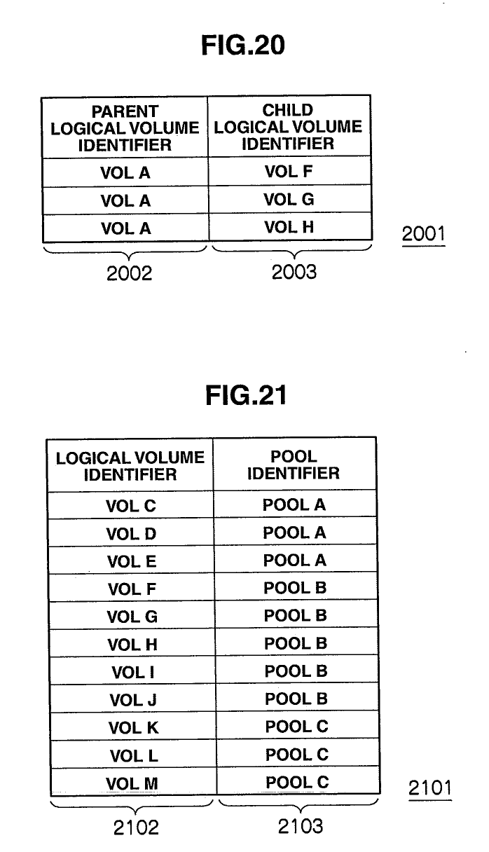

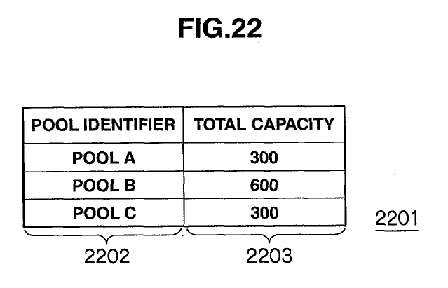

The resource configuration information 306 is configured from an application/file system relationship table 1301 (FIG. 13), a file system/logical device relationship table 1401 (FIG. 14), a file system/VM volume relationship table 1501 (FIG. 15), a VM volume/device group relationship table 1601 (FIG. 16), a device group/logical device relationship table 1701 (FIG. 17), a logical device/logical volume relationship table 1801 (FIG. 18), a logical volume table 1901 (FIG. 19), a compound logical volume/element logical volume relationship table 2001 (FIG. 20), a virtual logical volume/pool relationship table 2101 (FIG. 21) and a pool table 2201 (FIG. 22). These tables are created based on information collected by the agent information collection unit 301 from the storage monitoring agent 140, the host monitoring agent 126 and the application monitoring agent 123, and information collected by the application execution management information collection unit 313 from the application execution management software 112.

The application/file system relationship table 1301 is a table for managing the data I/O dependence between the application and the file system, and, as shown in FIG. 13, is configured from an application identifier storage column 1302 and a file system identifier storage column 1303. Each row of the application/file system relationship table 1301 corresponds to one data I/O relation between the application and the file system.

In the application/file system relationship table 1301, the identifier of the application is stored in the application identifier storage column 1302, and the identifier of the file system to which the corresponding application issues a data I/O request is stored in the file system identifier storage column 1303.

Accordingly, for example, the first row of FIG. 13 shows that the application 405 (FIG. 4) indicated as “AP_A” is of a relationship of issuing a data I/O request to the file system 423 (FIG. 4) indicated as “FS_A.”

The application/file system relationship table 1301 is created based on information collected by the agent information collection unit 301 from the application monitoring agent 123, and information collected by the application execution management information collection unit 313 from the application execution management software 112.

The file system/logical device relationship table 1401 is a table for managing the relationship of the file system and the logical device to which such file system is allocated, and, as shown in FIG. 14, is configured from a file system identifier storage column 1402 and a logical device identifier storage column 1403. Each row of the file system/logical device relationship table 1401 corresponds to one allocation relationship of the file system and the logical device.

In the file system/logical device relationship table 1401, the identifier of the file system is stored in the file system identifier storage column 1402, and the identifier of the logical device to which the corresponding file system is allocated is stored in the logical device identifier storage column 1403.

Accordingly, for example, the first row of FIG. 14 shows the relation where the file system 423 (FIG. 4) indicated as “FS_A” is allocated to the logical device 438 (FIG. 4) indicated as “DEV_A.”

The file system/logical device relationship table 1401 is created based on information collected by the agent information collection unit 301 from the file management system 124 via the host monitoring agent 126.

file system/VM volume relationship table 1501 is a table for managing the relationship of the file system and the VM volume to which such file system is allocated, and, as shown in FIG. 15, is configured from a file system identifier storage column 1502 and a VM volume identifier storage column 1503. Each row of the file system/VM volume relationship table 1501 corresponds to one allocation relation of the file system and the VM volume.

In the file system/VM volume relationship table 1501, the identifier of the corresponding file system is stored in the file system identifier storage column 1502, and the identifier of the VM volume to which the corresponding file system is allocated is stored in the VM volume identifier storage column 1503.

Accordingly, for example, the first row of FIG. 15 shows the relationship where the file system 428 (FIG. 4) indicated as “FS₋F” is allocated to the VM volume 432 (FIG. 4) indicated as “VM_VOL_A.”

The file system/VM volume relationship table 1501 is created based on information collected by the agent information collection unit 301 from the volume management software 125 via the host monitoring agent 126.

The VM volume/device group relationship table 1601 is a table for managing the relationship of the VM volume and the device group to which such VM volume is allocated, and, as shown in FIG. 16, is configured from a VM volume identifier storage column 1602 and a device group identifier storage column 1603. Each row of the VM volume/device group relationship table 1601 corresponds to one allocation relationship of the VM volume and the device group.

In this VM volume/device group relationship table 1601, the identifier of the VM volume is stored in the VM volume identifier storage column 1602, and the identifier of the device group to which the corresponding VM volume is allocated is stored in the device group identifier storage column 1603.

Accordingly, for example, the first row of FIG. 16 shows the relation where the VM volume 432 (FIG. 4) indicated as “VM_VOL_A” is allocated to the device group 436 (FIG. 4) indicated as “DEV_GR_A.”

The VM volume/device group relationship table 1601 is created based on information collected by the agent information collection unit 301 from the volume management software 125 via the host monitoring agent 126.

The device group/logical device relationship table 1701 is a table for managing the relationship of the device group and the logical device to which such device group is allocated, and, as shown in FIG. 17, is configured from a device group identifier storage column 1702 and a logical device identifier storage column 1703. Each row of the device group/logical device relationship table 1701 corresponds to one allocation relation of the device group and the logical device.

In the device group/logical device relationship table 1701, the identifier of the device group is stored in the device group identifier storage column 1702, and the identifier of the logical device to which the corresponding device group is allocated is stored in the logical device identifier storage column 1703.

Accordingly, for example, the first row of the FIG. 17 shows the relation where the device group 436 (FIG. 4) indicated as “DEV_GR A” is allocated to the logical device 443 (FIG. 4) indicated as “DEV_F.”

The device group/logical device relationship table 1701 is created based on information collected by the agent information collection unit 301 from the volume management software 125 via the host monitoring agent 126.

The logical device/logical volume relationship table 1801 is a table for managing the relationship of the host server-side logical device and the storage apparatus-side logical volume to which such logical device is allocated, and, as shown in FIG. 18, is configured from a logical device identifier storage column 1802 and a logical volume identifier storage column 1803. Each row of the logical device/logical volume relationship table 1801 corresponds to one correspondence of the logical device and the logical volume.

In the logical device/logical volume relationship table 1801, the identifier of the logical device is stored in the logical device identifier storage column 1802, and the identifier of the logical volume corresponding to the corresponding logical device is stored in the logical volume identifier storage column 1803.

Accordingly, for example, the first row of FIG. 18 shows the relation where the logical device 438 (FIG. 4) indicated as “DEV_A” corresponds to the logical volume 452 (FIG. 4) indicated as “VOL_B.”

The logical device/logical volume relationship table 1801 is created based on information collected by the agent information collection unit 301 from the host monitoring agent 126.

The logical volume table 1901 is a table for managing the attribute of the respective logical volumes (i.e., real logical volume, virtual logical volume, compound logical volume or pool volume) belonging to the storage apparatus, and, as shown in FIG. 19, is configured from a logical volume identifier storage column 1902, a volume type storage column 1903 and a defined capacity storage column 1904. Each row of the logical volume table 1901 corresponds to one logical volume.

In the logical volume table 1901, the identifier of the logical volume is stored in the logical volume identifier storage column 1902, a type code representing the type of such logical volume is stored in the volume type storage column 1903. A type code is “real” representing a real logical volume, “virtual” representing a virtual logical volume, “compound” representing a compound logical volume, or “pool” representing a pool volume. The defined capacity storage column 1904 stores the value showing the capacity defined in the corresponding logical volume.

Accordingly, for example, the first row of FIG. 19 shows that the logical volume 451 (FIG. 4) indicated as “VOL_A” is compound logical volume, and the defined capacity thereof is 600 GB.

The logical volume table 1901 is created based on information collected by the agent information collection unit 301 from the controller 147 of the storage apparatus 144 via the storage monitoring agent 140.

The compound logical volume/element logical volume relationship table 2001 is a table for managing the relationship of the compound logical volume, and the logical volumes configuring such compound logical volume. The compound logical volume/element logical volume relationship table 2001, as shown in FIG. 20, is configured from a parent logical volume identifier storage column 2002 and a child logical volume identifier storage column 2003.

In the compound logical volume/element logical volume relationship table 2001, the identifier of the compound logical volume is stored in the parent logical volume identifier storage column 2002, and the identifier of the logical volumes configuring such compound logical volume is stored in the child logical volume identifier storage column 2003.

Accordingly, for example, FIG. 20 shows that the compound logical volume 451 (FIG. 4) indicated as “VOL_A” is configured from three logical volumes 456, 457 and 458 indicated as “VOL_F,” “VOL_G,” and “VOL_H.”

The compound logical volume/element logical volume relationship table 2001 is created based on information collected by the agent information collection unit 301 from the controller 147 of the storage apparatus 144 via the storage monitoring agent 140.

The virtual logical volume/pool relationship table 2101 is a table for managing the relationship of the virtual logical volume and the pool to which such virtual logical volume is allocated, and, as shown in FIG. 21, is configured from a logical volume identifier storage column 2102 and a pool identifier storage column 2103. Each row of the virtual logical volume/pool relationship table 2101 corresponds to one allocation relation of the virtual logical volume and the pool.

In the virtual logical volume/pool relationship table 2101, the identifier of the virtual logical volume is stored in the logical volume identifier storage column 2102, and the identifier of the pool to which the corresponding virtual logical volume is allocated is stored in the pool identifier storage column 2103.

Accordingly, for example, the first row of FIG. 21 shows that the virtual logical volume 453 (FIG. 4) indicated as first row is allocated to the pool 464 (FIG. 4) indicated as “POOL_A.”

The virtual logical volume/pool relationship table 2101 is created based on information collected by the agent information collection unit 301 from the virtual volume management controller 149 of the storage apparatus 144 via the storage monitoring agent 140.

The pool table 2201 is a table for recording the attribute of the respective pools belonging to the storage apparatus. The pool table 2201, as shown in FIG. 22, is configured from a pool identifier storage column 2202 and a total capacity storage column 2203. Each row of the pool table 2201 corresponds to one pool.

In the pool table 2201, the identifier of the pool is stored in the pool identifier storage column 2202, and the value showing the total capacity of the corresponding pool is stored in the total capacity storage column 2203. The total capacity of the pool coincides with the total value of the capacity of pool volumes configuring the pool.

Accordingly, for example, the first row of FIG. 22 shows that the total capacity of the pool 464 (FIG. 4) indicated as “POOL_A” is “300” GB.

The pool table 2201 is created based on information collected by the agent information collection unit 301 from the virtual volume management controller 149 of the storage apparatus 144 via the storage monitoring agent 140.

(5-2) Configuration of Resource Statistical Information

An example of the table configuration and table structure of the resource statistical information 302 to be used by the storage management software 132 is now explained with reference to FIG. 23 to 25.

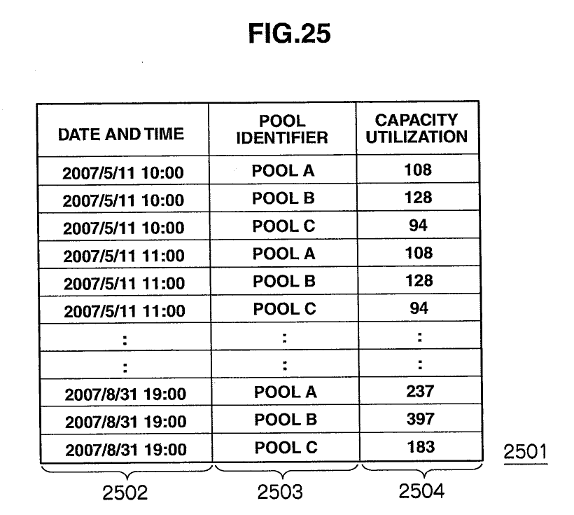

The resource statistical information 302 is configured from a file system statistical information table 2301 (FIG. 23), a virtual logical volume statistical information table 2401 (FIG. 24) and a pool statistical information table 2501 (FIG. 25). These tables are created based on information collected by the agent information collection unit 301 from the storage monitoring agent 140, the host monitoring agent 126 and the application monitoring agent 123.

The file system statistical information table 2301 is a table for managing the statistics of the file system measured at a prescribed timing (for instance, at a prescribed cycle), and, as shown in FIG. 23, is configured from a date and time storage column 2302, a file system identifier storage column 2303 and a capacity utilization storage column 2304. Each row of the file system statistical information table 2301 represents the statistics on a certain date and time of each file system.

In the file system statistical information table 2301, the date and time that the statistics were collected are stored in the date and time storage column 2302, and the identifier of the file system from which statistics are to be collected is stored in the file system identifier storage column 2303. The capacity utilization storage column 2304 stores the value of the capacity utilization collected regarding the corresponding file system.

Accordingly, for example, the first row of the FIG. 23 shows that “51” GB was acquired as the capacity utilization value concerning the file system 423 (FIG. 4) indicated as “FS_A” at 10:00 AM on May 11, 2007 (“May 11, 2007 10:00”).

The file system statistical information table 2301 is created based on information collected by the agent information collection unit 301 from the file management system 124 via the host monitoring agent 126.

The virtual logical volume statistical information table 2401 is a table for managing the statistics of the virtual logical volume measured at a prescribed timing (for instance, at a prescribed cycle), and, as shown in FIG. 24, is configured from a date and time storage column 2402, a logical volume identifier storage column 2403 and a capacity utilization storage column 2404. Each row of the virtual logical volume statistical information table 2401 represents the statistics on a certain date and time of each virtual logical volume.

In the virtual logical volume statistical information table 2401, the date and time that the statistics were collected are stored in the date and time storage column 2402, and the identifier of the virtual logical volume from which the statistics are to be collected is stored in the logical volume identifier storage column 2403. The capacity utilization storage column 2404 stores the value of the capacity utilization collected regarding the corresponding virtual logical volume.

Accordingly, for example, the first row of FIG. 24 shows that “52” GB was acquired as the capacity utilization value concerning the virtual logical volume 453 (FIG. 4) indicated as “VOL_C” at 10:00 AM on May 11, 2007 (“May 11, 2007 10:00”).

The virtual logical volume statistical information table 2401 is created based on information collected by the agent information collection unit 301 from the controller 147 of the storage apparatus 144 via the storage monitoring agent 140.

The pool statistical information table 2501 is a table for managing the statistics of the pool measured at a prescribed timing (for instance, at a prescribed cycle), and, as shown in FIG. 25, is configured from a date and time storage column 2502, a pool identifier storage column 2503 and a capacity utilization storage column 2504. Each row of the pool statistical information table 2501 represents the statistics on a certain date and time of each pool.

In the pool statistical information table 2501, the date and time that the statistics were collected are stored in the date and time storage column 2502, and the identifier of the pool from which the statistics are to be collected is stored in the pool identifier storage column 2503. The capacity utilization storage column 2504 stores the value of capacity utilization collected regarding the corresponding pool.

Accordingly, for example, the first row of FIG. 25 shows that “108” GB was acquired as the capacity utilization value concerning the pool 464 (FIG. 4) indicated as “POOL_A” at 10:00 AM on May 11, 2007.

The pool statistical information table 2501 is created based on information collected by the agent information collection unit 301 from the controller 147 of the storage apparatus 144 via the storage monitoring agent 140. The pool capacity utilization may be directly acquired from the virtual volume management controller 149 if possible, or calculated by totaling the capacity utilization of the virtual logical volumes acquired in the virtual logical volume statistical information table 2401 for each affiliated pool.

(5-3) Configuration of Selection Prioritization Condition Table

The selection prioritization condition table 303 to be used by the storage management software 132 is now explained.

FIG. 26 shows a configuration example of the selection prioritization condition table 303. The selection prioritization condition table 303 is a table for managing the selection and prioritization conditions, and is configured from a priority criterion storage column 2601, a pool unused capacity check flag storage column 2602, an inter-pool migration availability flag storage column 2603, a periodicity check flag storage column 2604 and an operation mode storage column 2605.

The priority criterion storage column 2601, the pool unused capacity check flag storage column 2602, the inter-pool migration availability flag storage column 2603, the periodicity check flag storage column 2604 and the operation mode storage column 2605 store the selection results (corresponding codes and flags) of the corresponding conditions selected by the user in the priority criterion column 520, the pool unused capacity check column 521, the periodicity check column 522, the operation mode column 523 and the inter-pool migration column 524 provided to the condition display area 503 of the migration plan display screen 500 explained with reference to FIG. 5.

For example, FIG. 26 shows a state where the migration candidate selection prioritization unit 309 (FIG. 3), as the selection and prioritization conditions upon selecting and prioritizing the migration plan, selected “unused capacity” as the priority criterion (refer to the priority criterion storage column 2601), selected the option that requires the performance of a check regarding the necessity to check the pool unused capacity (refer to the pool unused capacity check flag storage column 2602), selected the option of disabling the migration regarding the availability of migration of the file system across different pools (refer to the inter-pool migration availability flag storage column 2603), selected the option that does not require the performance of a check regarding the necessity to check the temporal increase or decrease of the file system capacity utilization (refer to the periodicity check flag storage column 2604), and selected the operation mode of “scheduled execution” regarding the operation mode of the storage management software 132 (refer to the operation mode storage column 2605).

The setting of the corresponding conditions in the priority criterion storage column 2601, the pool unused capacity check flag storage column 2602, the inter-pool migration availability flag storage column 2603, the periodicity check flag storage column 2604 and the operation mode storage column 2605 of the election prioritization condition table 303, as described above, is performed by the condition setting unit 304 according to the selections made by the user in the migration plan display screen 500.

(5-4) Configuration of File System/Virtual Logical Volume Correspondence Table

FIG. 27 shows a configuration example of the file system/virtual logical volume correspondence table 308. The file system/virtual logical volume correspondence table 308 is a table for managing the group of the file system and virtual logical volume on the same data I/O path, and, as shown in FIG. 27, is configured from an FS/VLV correspondence ID number storage column 2701, a file system identifier list storage column 2702, a logical volume identifier list storage column 2703, a file system total capacity utilization storage column 2704, a virtual logical volume total capacity utilization storage column 2705, a virtual logical volume unused capacity storage column 2706 and a virtual logical volume unused ratio storage column 2707. Each row of the file system/virtual logical volume correspondence table 308 corresponds to one pair configured from the pair of a file system group and a virtual logical volume group on the same data I/O path.

In the file system/virtual logical volume correspondence table 308, a number capable of uniquely identifying the registered rows of the file system/virtual logical volume correspondence table 308 is stored in the FS/VLV correspondence ID number storage column 2701. Among the pair of groups of the file system and the virtual logical volume on the same data I/O path, the list of identifiers of file systems belonging to the former is stored in the file system identifier list storage column 2702.

Among the pair of groups of the file system and the virtual logical volume on the same data I/O path, the list of identifiers of virtual logical volumes belonging to the latter is stored in the logical volume identifier list storage column 2703, and the total value (total capacity utilization) of capacity utilization of the file systems belonging to the group is stored in the file system total capacity utilization storage column 2704.

The total value of capacity utilization of the virtual logical volumes belonging to the group is stored in the virtual logical volume total capacity utilization storage column 2705, and the difference between the value of the virtual logical volume total capacity utilization storage column 2705 and the value of the file system total capacity utilization storage column 2704 is stored in the virtual logical volume unused capacity storage column 2706. This value signifies the capacity of the portion that is not being used by the file systems among the storage areas being sued by the virtual logical volumes belonging to the group.

The ratio of the value of the virtual logical volume unused capacity storage column 2706 and the value of the file system total capacity utilization storage column 2704 is stored in the virtual logical volume unused ratio storage column 2707. This value signifies the ratio of benefit (storage capacity to be collected) and the cost (capacity of data that needs to be copied) obtained by migrating the file system.

Accordingly, for example, the fifth row of FIG. 27 shows the relationship where the data I/O path that passes through either the file system 428 (FIG. 4) indicated as “FS_F” or the file system 429 (FIG. 4) indicated as “FS_G” in the host server 404 (FIG. 4) indicated as “D” passes through either the virtual logical volume 459 (FIG. 4) indicated as “VOL_I” and the virtual logical volume 460 (FIG. 4) indicated as “VOL_J” in the storage apparatus 450 (FIG. 4).

In addition, the fifth row of FIG. 27 shows that the total capacity utilization of the file system 428 (FIG. 4) indicated as “FS_F” and the file system 429 indicated as “FS_G” is 141 GB, the total capacity utilization of the virtual logical volume 459 (FIG. 4) indicated as “VOL_I” and the virtual logical volume 460 (FIG. 4) indicated as “VOL_J” is 179 GB, the capacity of the portion that is not being used by the file system 428 (FIG. 4) indicated as “FS_F” and the file system 429 (FIG. 4) indicated as “FS_G” among the storage areas used by the virtual logical volume 459 (FIG. 4) indicated as “VOL_I” and the virtual logical volume 460 (FIG. 4) indicated as “VOL_J” is 38 GB (=179 GB−141 GB), and the ratio of the storage capacity to be collected as a result of migrating the file system and the data capacity required for copying data is 27% (=38 GB÷141 GB).

The contents of the FS/VLV correspondence ID number storage column 2701, the file system identifier list storage column 2702 and the logical volume identifier list storage column 2703 in the file system/virtual logical volume correspondence table 308 are created and stored by the file system/virtual logical volume correspondence search unit 307 based on the configuration information stored in the resource configuration information 306. In addition, the contents of the file system total capacity utilization storage column 2704, the virtual logical volume total capacity utilization storage column 2705, the virtual logical volume unused capacity storage column 2706, and the virtual logical volume unused ratio storage column 2707 in the file system/virtual logical volume correspondence table 308 are calculated and stored by the migration candidate selection prioritization unit 309 based on the statistics stored in the resource statistical information 302.

(5-5) Configuration of File System Migration Control Table

FIG. 28 shows a configuration example of the file system migration control table 310. The file system migration control table 310 is a table for managing the migration plan of file systems, and, as shown in FIG. 28, is configured from a migration priority storage column 2801, an FS/VLV correspondence ID number storage column 2802, a migration flag storage column 2803, a used pool identifier storage column 2804, a migration destination logical volume identifier list storage column 2805, a POOL_A pre-migration unused capacity storage column 2806, a POOL A post-migration unused capacity storage column 2807, a POOL_B pre-migration unused capacity storage column 2808, a POOL_B post-migration unused capacity storage column 2809, a POOL_C pre-migration unused capacity storage column 2810 and a POOL_C post-migration unused capacity storage column 2811. Each row of the file system migration control table 310 corresponds to a migration plan concerning the file system group stored in the corresponding row of the file system/virtual logical volume correspondence table 308.

In the file system migration control table 310, the priority of executing the migration plan corresponding to that row is stored in the migration priority storage column 2801. This priority is the migration priority of the corresponding file system group decided by the migration candidate selection prioritization unit 309 (FIG. 3) based on the priority criterion set by the user in the condition display area 503 (FIG. 5) of the migration plan display screen 500 (FIG. 5).

The FS/VLV correspondence ID number storage column 2802 stores the number stored in the FS/VLV correspondence ID number column 2701 of the file system/virtual logical volume correspondence table 308 (FIG. 27). Based on this number, the respective rows of the file system migration control table 310 and the respective rows of the file system/virtual logical volume correspondence table 308 (FIG. 27) are made to correspond.

The used pool identifier storage column 2804 stores the identifier of the pool (that is, pool stored in the file system after migration) associated with the migration destination logical volume, and the migration destination logical volume identifier list storage column 2805 stores the identifier of the migration destination logical volume. In other foregoing case, if the file system is to be migrated to two or more logical volumes, the identifier of all migration destination logical volumes is stored.

The POOL_A pre-migration unused capacity storage column 2806 and the POOL_A post-migration unused capacity storage column 2807 respectively store the unused capacity of the pool indicated as “POOL_A” before and after the execution of the migration plan of that row. Similarly, the POOL_B pre-migration unused capacity storage column 2808 and the POOL_B post-migration unused capacity storage column 2809 respectively store the unused capacity of the pool indicated as “POOL_B” before and after the execution of the migration plan of that row, and the POOL_C pre-migration unused capacity storage column 2810 and the POOL_C post-migration unused capacity storage column 2811 respectively store the unused capacity of the pool indicated as “POOL_C” before and after the execution of the migration plan of that row.

In the foregoing case, the unused capacity to be respectively stored in the POOL_A pre-migration unused capacity storage column 2806, the POOL_B pre-migration unused capacity storage column 2808, and the POOL_C pre-migration unused capacity storage column 2810 of the respective rows is the unused capacity when the file system is migrated according to the order of priority stored in the migration priority storage column 2801. For example, when the migration plan having a priority of “1” is executed, since the unused capacity of the pool indicated as “POOL_A” after migration is “104” GB, “104” GB will be stored in the POOL_A pre-migration unused capacity storage column 2806 of the next row.

In this embodiment explained, the explanation is provided on the assumption that there are the three pools of “POOL A” to “POOL_C,” three pre-migration unused capacity storage columns 2806, 2808, 2810 and three post-migration unused capacity storage columns 2807, 2809, 2811 are provided in association with the respective pools, the quantity of these pre-migration unused capacity storage columns 2806, 2808, 2810 and the post-migration unused capacity storage columns 2807, 2809, 2811 may be a number other than three since they are provided in correspondence with the respective pools existing in the storage apparatus.

The migration flag storage column 2803 stores a migration flag showing whether it is possible to migrate the file system group corresponding to that row. Specifically, the migration candidate selection prioritization unit 309 determines whether the migration of the file system can be actually executed according to the migration plan, and, based on the determination result, the migration flag of “Y” is stored in the migration flag column 2803 when migration can be executed, and the migration flag of “N” is stored in the migration flag column 2803 when migration cannot be executed. Incidentally, FIG. 28 shows a case where the setting prohibits the migration of the file system across pools.

For example, with the migration plan having a priority of “1” (migration plan in the first row of the file system migration control table 310), when referring to the row (row where the value of the FS/VLV correspondence ID number storage column is “3”) corresponding to the file system/virtual logical volume correspondence table 308 (FIG. 27), the total capacity utilization of the migration target file system (“FS_D”) is “52” GB, and the virtual logical volume corresponding to this file system is the virtual logical volume indicated as “VOL_E.” When referring to the virtual logical volume/pool relationship table 2101 (FIG. 21), the pool allocated with the virtual logical volume indicated as “VOL_E” is the pool indicated as POOL_A,” and, upon referring to the file system migration control table 310, the unused capacity thereof is “63” GB. Accordingly, in the foregoing case, since the pool indicated as “POOL_A” before the file system is migrated is greater than the total capacity utilization of such file system, this file system can be migrated. Thus, in this case, “Y” is stored in the migration flag storage column 2803 of the first row of the file system migration control table 310.

Meanwhile, with the migration plan having a priority of “5” (migration plan in the fifth row of the file system migration control table 310), when referring to the row (row where the value of the FS/VLV correspondence ID number storage column is “6”) corresponding to the file system/virtual logical volume correspondence table 308 (FIG. 27), the total capacity utilization of the migration target file systems (“FS_H” and “FS_I”) is “125” GB, and the virtual logical volumes corresponding to these file systems are the virtual logical volumes indicated as “VOL I” and “VOL_J.” When referring to the virtual logical volume/pool relationship table 2101 (FIG. 21), the pool allocated with the virtual logical volumes indicated as “VOL_I” and “VOL_J” is the pool indicated as “POOL_B,” and, upon referring to the file system migration control table 310, the unused capacity thereof is “117” GB. Thus, in this case, since the unused capacity of the pool indicated as “POOL_B” before the file system is migrated is smaller than the total capacity utilization of such file system, this file system cannot be migrated. Thus, in this case, “N” is stored in the migration flag storage column 2803 of the fifth row of the file system migration control table 310.

(5-6) Configuration of Application Execution Schedule Table

FIG. 29 shows a configuration example of the application execution schedule table 314. The application execution schedule table 314 is a table for managing the execution schedule of each of the pre-set applications 122 (FIG. 1), and is configured from an application identifier storage column 2901, an execution start date and time storage column 2902 and an execution end date and time storage column 2903. Each row of the application execution schedule table 314 corresponds to one execution schedule of the application 122.

In the application execution schedule table 314, the identifier of the processing of the application 122 scheduled to be executed is stored in the application identifier storage column 2901. In addition, the execution start date and time of such processing is stored in the execution start date and time storage column 2902, and the execution end data of such processing is stored in the execution end date and time storage column 2903.

Accordingly, for example, the first row of FIG. 29 shows that the processing of the application 122 indicated as “AP A” is started at 12:00 AM on Sep. 2, 2007 (“Sep. 2, 2007 00:00”), and such processing is scheduled to be ended at 3:00 AM on Sep. 2, 2007 (“Sep. 2, 2007 00:30”).

The contents of the application identifier storage column 2901, the execution start date and time storage column 2902 and the execution end date and time storage column 2903 of the application execution schedule table 314 are stored based on the execution management information collected by the application execution management information collection unit 313 from the application execution management software 112 (FIG. 3).

(5-7) Configuration of File System Usage Schedule Table

FIG. 30 shows a configuration example of the file system usage schedule table 316. The file system usage schedule table 316 is a table for managing the usage schedule of the file system, and, as shown in FIG. 30, configured from a file system identifier storage column 3001, a usage start date and time storage column 3002 and a usage end date and time storage column 3003. Each row of the file system usage schedule table 316 corresponds to one usage schedule of the file system.

In the file system usage schedule table 316, the identifier of the file system to be used pursuant to the execution schedule of the application 122 is stored in the file system identifier storage column 3001. In addition, the schedule date and time of starting the use of the file system is stored in the execution start date and time storage column 3002, and the schedule date and time of ending the use of the file system is stored in the execution end date and time storage column 3003.

Accordingly, for example, the first row of FIG. 30 shows that the use of the file system indicated as “FS_A” is started at 12:00 AM on the Sep. 2, 2007 (“Sep. 2, 2007 00:00”), and scheduled to be ended at 3:00 AM on Sep. 2, 2007 (“Sep. 2, 2007 03:00”).

The contents of the file system identifier storage column 3001, the usage start date and time storage column 3002 and the usage end date and time storage column 3003 of the file system usage schedule table 316 are stored by the file system usage schedule creation unit 315 based on the application execution schedule table 314, and the application/file system relationship table 1301 of the resource configuration information 306.

(5-8) Configuration of File System Migration Schedule Table

FIG. 31 shows a configuration example of the file system migration schedule table 318. The file system migration schedule table 318 is a table for managing the file system migration schedule, and, as shown in FIG. 31, is configured from a file system identifier storage column 3101, a migration start date and time storage column 3102, a scheduled migration end date and time storage column 3103 and a migration discontinuance date and time storage column 3104. Each row of the file system migration schedule table 318 corresponds to one file system migration schedule.

In the file system migration schedule table 318, the identifier of the migration target file system is stored in the file system identifier storage column 3101. In addition, the schedule date and time of starting the migration of the file system is stored in the migration start date and time storage column 3102, and the scheduled date and time of ending the migration of the file system is stored in the scheduled migration end date and time storage column 3103.

Further, the maximum extendable date and time when the migration of the file system does not end as scheduled are stored in the migration discontinuance date and time storage column 3104. If the migration of the file system still does not end even upon reaching the foregoing date and time, the migration of the file system is discontinued.

Accordingly, for example, the first row of FIG. 31 shows that the migration of the file system indicated as “FS_D” is started at 3:00 AM on Sep. 2, 2007 (“Sep. 2, 2007 03:00”), is scheduled to be ended at 3:17 AM on Sep. 2, 2007 (“Sep. 2, 2007 03:17”), and, if the migration is not complete by 3:30 AM on Sep. 2, 2007 (“Sep. 2, 2007 03:30”), this migration will be discontinued.

The contents of the file system identifier storage column 3101, the migration start date and time storage column 3102, the scheduled migration end date and time storage column 3103 and the migration discontinuance date and time storage column 3104 of the file system migration schedule table 318 are stored by the migration schedule creation unit 317 based on the statistics stored in the resource statistical information 302, the correspondence information stored in the file system/virtual logical volume correspondence table 308, the migration plan stored in the file system migration control table 310, and the schedule stored in the file system usage schedule table 316.

### (6) Various Types of Processing with Storage Management Software

The processing contents of the various types of processing to be executed by the program module of the storage management software 132 are now explained with reference to FIG. 32 to FIG. 38.

(6-1) File System/Virtual Logical Volume Correspondence Search Processing

FIG. 32 shows the processing routine of file system/virtual logical volume correspondence search processing for searching and associating the file system group and the virtual logical volume group sharing the same data I/O path to be executed by the file system/virtual logical volume correspondence search unit 307 configuring the storage management software 132.

This file system/virtual logical volume correspondence search processing is executed at a prescribed timing. For example, the file system/virtual logical volume correspondence search processing is executed periodically according to the scheduling setting using a timer or the like. This file system/virtual logical volume correspondence search processing, in reality, is executed by the CPU 129 that executes the storage management software 132.

When the file system/virtual logical volume correspondence search unit 307 starts the file system/virtual logical volume correspondence search processing, it foremost accesses each row of the logical volume table 1901 (FIG. 19) in order from the top, and determines whether there are no unprocessed rows in the file system/virtual logical volume correspondence search processing, and whether to end this processing (SP1).

When the file system/virtual logical volume correspondence search unit 307 obtains a negative result in this determination, it acquires a row number corresponding to the unprocessed logical volume from the logical volume table 1901 (SP2).

Subsequently, the file system/virtual logical volume correspondence search unit 307 checks the values respectively stored in the logical volume identifier storage column 1902 and the volume type storage column 1903 of the row in which the row number thereof was acquired at step SP2 in the logical volume table 1901 (SP3).

Then, the file system/virtual logical volume correspondence search unit 307 returns to step SP1 when the value stored in the logical volume identifier storage column 1902 coincides with any one of the values stored in the logical volume identifier list storage column 2703 of any one of the rows registered in the file system/virtual logical volume correspondence table 308 (FIG. 27), or the value stored in the volume type storage column 1903 is other than “virtual.”

Meanwhile, the file system/virtual logical volume correspondence search unit 307 newly registers a virtual logical volume in the file system/virtual logical volume correspondence table 308 when the value stored in the logical volume identifier storage column 1902 does not coincide with any one of the values stored in the logical volume identifier list storage column 2703 of any one of the rows registered in the file system/virtual logical volume correspondence table 308, and the value stored in the volume type storage column 1903 is “virtual” (SP4).

Specifically, the file system/virtual logical volume correspondence search unit 307 foremost adds a new row to the file system/virtual logical volume correspondence table 308, and thereafter stores an unused ID number capable of differentiating this row with the other previously registered rows in the FS/VLV correspondence ID number storage column 2701 (FIG. 27) of the added row. The file system/virtual logical volume correspondence search unit 307 also stores the value stored in the logical volume identifier storage column 1902 of the row in which the row number thereof was acquired at step SP2 of the logical volume table 1901 in the logical volume identifier list storage column 2703 (FIG. 27) of the file system/virtual logical volume correspondence table 308.

Subsequently, the file system/virtual logical volume correspondence search unit 307 searches for all file systems in which the related information between the resources can retroactively reach the host server side in sequence with the value stored in the logical volume identifier storage column 1902 of the row in which the row number thereof was acquired at step SP2 of the logical volume table 1901 as the origin.

Specifically, the file system/virtual logical volume correspondence search unit 307 foremost sets the value stored in the logical volume identifier storage column 1902 of the row in which the row number thereof was acquired at step SP2 of the logical volume table 1901 as the identifier of the search target logical volume.

Subsequently, the file system/virtual logical volume correspondence search unit 307 checks whether there is a row in which the value stored in the child logical volume identifier storage column 2003 (FIG. 20) of the compound logical volume/element logical volume relationship table 2001 (FIG. 20) coincides with the identifier of the search target logical volume, and, if there is such a row, it once again sets the value stored in the parent logical volume identifier storage column 2002 (FIG. 20) of that row as the identifier of the search target logical volume.

Subsequently, the file system/virtual logical volume correspondence search unit 307 searches whether there is a row where the value stored in the logical volume identifier storage column 1803 (FIG. 18) of the logical device/logical volume relationship table 1801 (FIG. 18) coincides with the identifier of the search target logical volume, and sets the value stored in the logical device identifier storage column 1802 (FIG. 18) of the row detected in the foregoing search as the identifier of the search target logical device.

Subsequently, the file system/virtual logical volume correspondence search unit 307 searches for a row where the value stored in the logical device identifier storage column 1403 (FIG. 14) of the file system/logical device relationship table 1401 (FIG. 14) coincides with the identifier of the search target logical device. If there is a corresponding row, the value stored in the file system identifier storage column 1402 (FIG. 14) of that row is the identifier of the file system being sought.

Meanwhile, if there is no corresponding row in the file system/logical device relationship table 1401, the file system/virtual logical volume correspondence search unit 307 searches for a row where the value stored in the logical device identifier storage column 1703 (FIG. 17) of the device group/logical device relationship table 1701 (FIG. 17) coincides with the identifier of the search target logical device, and sets the value stored in the device group identifier storage column 1702 (FIG. 17) of the corresponding row as the identifier of the search target device group.

Subsequently, the file system/virtual logical volume correspondence search unit 307 searches for a row where the value stored in the device group identifier storage column 1603 (FIG. 16) of the VM volume/device group relationship table 1601 (FIG. 16) coincides with the identifier of the search target device group, and sets the value stored in the VM volume identifier storage column 1602 (FIG. 16) of all corresponding rows as the identifier of the search target VM volume.

Further, the file system/virtual logical volume correspondence search unit 307 searches for all rows where the value stored in the VM volume identifier storage column 1503 (FIG. 15) of the file system/VM volume relationship table 1501 (FIG. 15) coincides with the identifier of any one of the search target VM volumes. The value stored in the file system identifier storage column 1502 (FIG. 15) of each of the searched corresponding rows is the identifier of the file system being sought.

The file system/virtual logical volume correspondence search unit 307 stores the identifier of all file systems obtained as described above in the file system identifier list storage column 2702 (FIG. 27) corresponding to the file system/virtual logical volume correspondence table 308 (SP5).

Subsequently, the file system/virtual logical volume correspondence search unit 307 searches for all virtual logical volumes in which the related information between the resources can retroactively reach the storage apparatus side in sequence with all file systems obtained at step SP5 as the origin, and stores the identifier of all discovered virtual logical volumes in the logical volume identifier list storage column 2703 of the file system/virtual logical volume correspondence table 308 (SP6).

Specifically, the file system/virtual logical volume correspondence search unit 307 foremost sets all file systems in which the identifier was obtained at step SP5 as the search target file systems, and searches for all rows where the value stored in the file system identifier storage column 1402 (FIG. 14) of the file system/logical device relationship table 1401 (FIG. 14) coincides with the identifier of any one of the search target file systems. If a corresponding row exists, the file system/virtual logical volume correspondence search unit 307 sets the values respectively stored in the logical device identifier storage column 1403 (FIG. 14) of all corresponding rows as the identifier of the search target logical device.

Meanwhile, if there is no corresponding row in the file system/logical device relationship table 1401, the file system/virtual logical volume correspondence search unit 307 searches for all rows where the value storing the file system identifier storage column 1502 (FIG. 15) of the file system/VM volume relationship table 1501 (FIG. 15) coincides with the identifier of any one of the search target file systems. Then, the file system/virtual logical volume correspondence search unit 307 sets the value stored in the VM volume identifier storage column 1503 (FIG. 15) of all searched corresponding rows as the identifier of the search target VM volume.

Subsequently, the file system/virtual logical volume correspondence search unit 307 searches for all rows where the value stored in the VM volume identifier storage column 1602 (FIG. 16) of the VM volume/device group relationship table 1601 (FIG. 16) coincides with the identifier of any one of the search target VM volumes, and sets the value stored in the device group identifier storage column 1603 (FIG. 16) of all corresponding rows as the identifier of the search target device group.

Further, the file system/virtual logical volume correspondence search unit 307 searches for all rows where the value stored in the device group identifier storage column 1702 (FIG. 17) of the device group/logical device relationship table 1701 (FIG. 17) coincides with the identifier of any one of the search target device groups, and sets the value stored in the logical device identifier storage column 1703 (FIG. 17) of all corresponding rows as the identifier of the search target logical device.

When the identifier of the search target logical device is obtained with any one of the foregoing methods, the file system/virtual logical volume correspondence search unit 307 subsequently searches for all rows where the value stored in the logical device identifier storage column 1802 (FIG. 18) of the logical device/logical volume relationship table 1801 (FIG. 18) coincides with the identifier of any one of the search target logical devices, and sets the value stored in the logical volume identifier storage column 1803 (FIG. 18) of all corresponding rows as the identifier of the search target logical volume.

Subsequently, the file system/virtual logical volume correspondence search unit 307 searches for a row where the value stored in the parent logical volume identifier storage column 2002 (FIG. 20) of the compound logical volume/element logical volume relationship table 2001 (FIG. 20) coincides with the identifier of any one of the search target logical volumes, and, if there is one or more such rows, replaces the corresponding identifier of the search target logical volume with all values stored in the child logical volume identifier storage column 2003 (FIG. 20) of the corresponding rows. Further, the file system/virtual logical volume correspondence search unit 307 searches for a row where the value stored in the logical volume identifier storage column 1902 (FIG. 19) of the logical volume table 1901 (FIG. 19) coincides with the identifier of any one of the search target logical volumes, and, when the value stored in the volume type storage column 1903 (FIG. 19) of the corresponding row is not “virtual,” excludes the value stored in the logical volume identifier storage column 1902 (FIG. 19) of the corresponding row from the search target logical volume.

Subsequently, the file system/virtual logical volume correspondence search unit 307 stores the identifier of all logical volumes sought as described above in the logical volume identifier list storage column 2703 (FIG. 27) of the file system/virtual logical volume correspondence table 308, thereafter returns to step SP1, and repeats the same processing until it eventually obtains a positive result at step SP1.

When the file system/virtual logical volume correspondence search unit 307 eventually obtains a positive result at step SP1 as a result of completing the processing regarding all rows of the logical volume table 1901, it ends this file system/virtual logical volume correspondence search processing.

(6-2) Migration Candidate Selection Prioritization Processing

Meanwhile, FIG. 33 shows the processing routine of migration candidate selection prioritization processing for selecting and prioritizing the migration candidate file system to be executed by the migration candidate selection prioritization unit 309 (FIG. 3) configuring the storage management software 132.

This migration candidate selection prioritization processing is executed at a prescribed timing. For example, the migration candidate selection prioritization processing is executed periodically according to the scheduling setting using a timer or the like. The migration candidate selection prioritization processing may also be started based on a request from the storage management client 103 issued according to the user's operation. The migration candidate selection prioritization processing, in reality, is executed by the CPU 129 that executes the storage management software 132.

When the migration candidate selection prioritization unit 309 starts the migration candidate selection prioritization processing, it foremost refers to the file system statistical information table 2301 (FIG. 23) and the virtual logical volume statistical information table 2401 (FIG. 24) regarding the respective pairs configured from the file system group and the virtual logical volume group on the same data I/O path registered in the respective rows of the file system/virtual logical volume correspondence table 308 (FIG. 27) in the file system/virtual logical volume correspondence search processing explained with reference to FIG. 32, and calculates the total capacity utilization of the file system group and the virtual logical volume group, and the unused capacity and the unused ratio of the virtual logical volume, respectively. Then, the migration candidate selection prioritization unit 309 respectively stores the foregoing calculation results in the corresponding file system total capacity utilization storage column 2704 (FIG. 27), the corresponding virtual logical volume total capacity utilization storage column 2705 (FIG. 27), the corresponding virtual logical volume unused capacity storage column 2706 (FIG. 27) and the corresponding virtual logical volume unused ratio storage column 2707 (FIG. 27) of the file system/virtual logical volume correspondence table 308 (SP1 0).

Subsequently, the migration candidate selection prioritization unit 309 refers to the priority criterion storage column 2601 (FIG. 26) of the selection prioritization condition table 303 (FIG. 26), and confirms whether the set priority criterion is an “unused capacity” or an “unused ratio” (SP11).

When the set priority criterion is an “unused capacity,” the migration candidate selection prioritization unit 309 refers to the unused capacity stored in the virtual logical volume unused capacity storage column 2706 of the file system/virtual logical volume correspondence table 308 (FIG. 27), and registers necessary information concerning the respective rows of the file system/virtual logical volume correspondence table 308 in the file system migration control table 310 (FIG. 28) so that greater the unused capacity, higher the migration priority (SP12).

Specifically, the migration candidate selection prioritization unit 309 stores the value of the FS/VLV correspondence ID number storage column 2701 of the respective rows of the file system/virtual logical volume correspondence table 308 in the FS/VLV correspondence ID number storage column 2802 of the file system migration control table 310 so that greater the unused capacity, higher the migration priority (smaller the value of the migration priority storage column). Moreover, the migration candidate selection prioritization unit 309 reads the pool identifiers associated with the logical volume identifiers stored respectively in the logical volume identifier list storage column 2703 from the virtual logical volume/pool relationship table 2101 (FIG. 21) regarding the respective rows of the file system/virtual logical volume correspondence table 308, and stores this in the corresponding used pool identifier storage column 2804 of the file system migration control table 310.

Further, the migration candidate selection prioritization unit 309 newly creates logical volume identifiers in the same quantity as the identifiers respectively stored in the logical volume identifier list storage column 2703 regarding the respective rows of the file system/virtual logical volume correspondence table 308, and stores the created identifiers in the migration destination logical volume identifier list storage column 2805 of the file system migration control table 310.

Moreover, the migration candidate selection prioritization unit 309 respectively calculates the unused capacity of the respective pools before migration and the unused capacity of the respective pools after migration when the corresponding file is migrated based on the total capacity of the respective pools stored in the pool table 2201 (FIG. 22), the capacity utilization of the respective pools stored in a row in which the date and time storage column 2502 of the pool statistical information table 2501 is latest, and the unused capacity of the corresponding virtual logical volume stored in the file system/virtual logical volume correspondence table 308, and respectively stores the calculation result in the corresponding storage column among the POOL_A pre-migration unused capacity storage column 2806, the POOL_A post-migration unused capacity storage column 2807, the POOL_B pre-migration unused capacity storage column 2808, the POOL_B post-migration unused capacity storage column 2809, the POOL_C pre-migration unused capacity storage column 2810 and the POOL_C post-migration unused capacity storage column 2811.

The migration candidate selection prioritization unit 309 thereafter stores the migration flag representing “Y” in the migration flag storage column 2803 of all rows of the file system migration control table 310, respectively.

Meanwhile, if the set priority criterion is an “unused ratio,” the migration candidate selection prioritization unit 309 refers to the unused ratio stored n the virtual logical volume unused ratio storage column 2707 of the file system/virtual logical volume correspondence table 308 (FIG. 27), and registers necessary information concerning the respective rows of the file system/virtual logical volume correspondence table 308 in the file system migration control table 310 (FIG. 28) so that higher the unused ratio, higher the migration priority (SP13). The specific processing contents of the migration candidate selection prioritization unit 309 at step SP13 are roughly the same as the processing contents at step SP12, and the explanation thereof is omitted.

When the migration candidate selection prioritization unit 309 completes the processing at step SP12 or step SP13, it refers to the periodicity check flag storage column 2604 (FIG. 26) of the selection prioritization condition table 303 (FIG. 26), and determines whether the setting requires the checking of the temporal increase or decrease of the file system capacity utilization (SP14).

When the migration candidate selection prioritization unit 309 obtains a negative result in this determination, it proceeds to step SP16. Contrarily, when the migration candidate selection prioritization unit 309 obtains a positive result in this determination, it refers to the file system statistical information table 2301 of the resource statistical information 302 regarding the respective rows of the file system migration control table 310, checks whether the capacity utilization of the respective corresponding file systems is increasing or decreasing pursuant to the passage of time, and reviews the selection and prioritization based on such result (SP15).

Subsequently, the migration candidate selection prioritization unit 309 refers to the pool unused capacity check flag storage column 2602 (FIG. 26) of the selection prioritization condition table 303 (FIG. 26), and determines whether the setting request the checking of the pool unused capacity (SP16). When the migration candidate selection prioritization unit 309 obtains a negative result in this determination, it ends this migration candidate selection prioritization processing.

Meanwhile, when the migration candidate selection prioritization unit 309 obtains a positive result in this determination, it checks the unused capacity of the corresponding pool and reviews the selection and prioritization based on the result regarding the respective rows of the file system migration control table 310 (SP17). The migration candidate selection prioritization unit 309 thereafter ends this migration candidate selection prioritization processing.

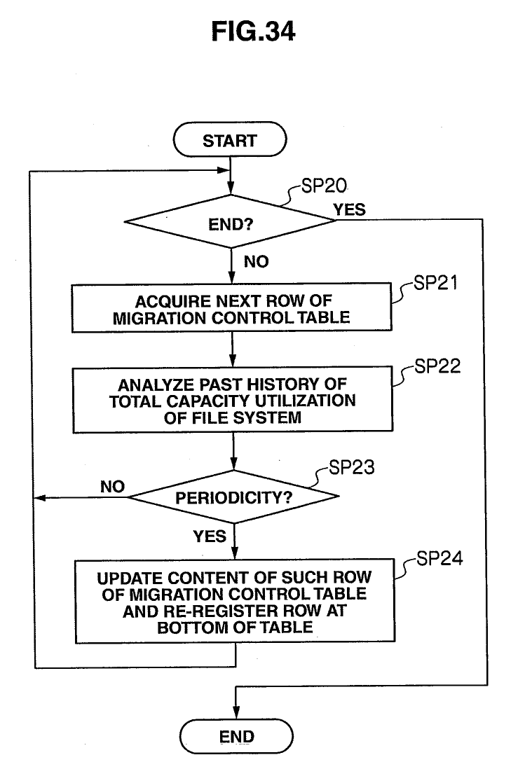

The specific processing contents of the migration candidate selection prioritization unit 309 at step SP15 of the foregoing migration candidate selection prioritization processing are shown in FIG. 34. When the migration candidate selection prioritization unit 309 proceeds to step SP15 of the migration candidate selection prioritization processing, it starts the periodicity check processing shown in FIG. 34, and foremost determines whether the processing of step SP21 to step SP24 described later has been fully performed to all rows of the file system migration control table 310 (SP20).

When the migration candidate selection prioritization unit 309 obtains a negative result in this determines, it acquires the row number of the next row of the file system migration control table 310. Nevertheless, the migration candidate selection prioritization unit 309 initially acquires the row number of the top row of the file system migration control table 310 (SP21).

Subsequently, the migration candidate selection prioritization unit 309 refers to the file system statistical information table 2301, and analyzes the past history of the total capacity utilization of the file system corresponding to the row in which the row number thereof was acquired at the immediately preceding step SP21 (SP22), and thereafter determines whether the capacity utilization of such file system is increasing or decreasing pursuant to the passage of time based on the foregoing analysis (SP23). As the method of determining the temporal increase or decrease, for instance, a method of checking whether the maximum value and the minimum value of a prescribed ratio or greater repeatedly appearing a prescribed number of times or more in a time-oriented change of data can be employed.

When the migration candidate selection prioritization unit 309 obtains a negative result in this determination, it returns to step SP20. Contrarily, when the migration candidate selection prioritization unit 309 obtains a positive result in this determination, it changes the migration flag stored in the migration flag storage column 2804 of the corresponding row of the file system migration control table 310 from “Y” to “N,” thereafter re-registers this row at the bottom of the file system migration control table 310, and re-registers the subsequent rows by bumping them up toward the table top direction (SP24). Further, the migration candidate selection prioritization unit 309 deletes the contents of the used pool identifier storage column 2804 and the migration destination logical volume identifier list storage column 2805 of the row moved to the bottom of the table, and re-performs the calculation of the unused capacity of the respective pools before migration at step SP12 regarding the unused capacities that were rearranged in the rows of the file system migration control table 310. Then, the migration candidate selection prioritization unit 309 returns to step SP20, and thereafter repeats the same processing (SP20 to SP24-SP20).

When the migration candidate selection prioritization unit 309 eventually obtains a positive result at step SP20 as a result of completing the same processing regarding all rows of the file system migration control table 310, it ends this periodicity check processing.

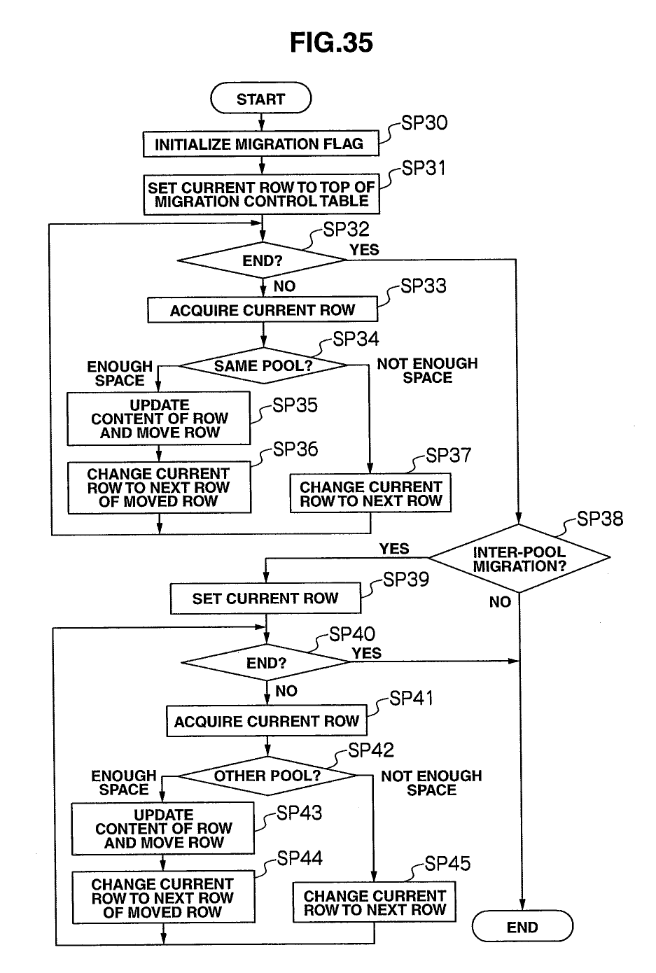

Meanwhile, FIG. 35 shows the specific processing contents of the migration candidate selection prioritization unit 309 at step SP17 of the foregoing migration candidate selection prioritization processing. When the migration candidate selection prioritization unit 309 proceeds to step SP17 of the migration candidate selection prioritization processing, it starts the pool unused capacity check processing shown in FIG. 35, and foremost changes the value of the migration flag storage column 2803 to “TBD” regarding all rows in which the value stored in the migration flag storage column 2803 is “Y” among the rows of the file system migration control table 310 (SP30).

Subsequently, the migration candidate selection prioritization unit 309 sets the pointer to the top row of the file system migration control table 310 (SP31), and thereafter determines whether the processing of step SP33 to step SP37 described later has been performed to all rows in which the value stored in the migration flag storage column 2803 is “TBD” among the rows of the file system migration control table 310 (SP32).

When the migration candidate selection prioritization unit 309 obtains a negative result in this determination, it acquires the row number of the row set with the pointer (SP33), and thereafter determines whether there is unused capacity of the pool necessary for temporarily copying data for migrating the file system in the pool that is the same as the pool associated with the target file system based on the value stored in the file system total capacity utilization storage column 2704 of the corresponding row of the file system/virtual logical volume correspondence table 308, and the value stored in the POOL_A pre-migration unused capacity storage column 2806, the POOL_A post-migration unused capacity storage column 2807, the POOL_B pre-migration unused capacity storage column 2808, the POOL_B post-migration unused capacity storage column 2809, the POOL_C pre-migration unused capacity storage column 2810 and the POOL_C post-migration unused capacity storage column 2811 of the row of the row number that is one number smaller than the current row number of the file system migration control table 310 (SP34).

When the migration candidate selection prioritization unit 309 obtains a positive result in this determination, it updates the migration flag stored in the migration flag storage column 2803 of that row to “Y,” and then moves that row to the top of all rows in which the value stored in the migration flag storage column 2803 is “TBD” among the rows of the file system migration control table 310 (SP35). Further, the migration candidate selection prioritization unit 309 re-executes the calculation of the unused capacity of the respective pools after migration at step SP12 regarding all rows of the moved row onward. The migration candidate selection prioritization unit 309 changes the pointer set in the file system migration control table 310 to the next row of the row to which the pointer was moved (SP36), and thereafter returns to step SP32.

Meanwhile, when the migration candidate selection prioritization unit 309 obtains a negative result in this determination, it changes the pointer set in the file system migration control table 310 to the next row (SP37), and thereafter returns to step SP32.

When the migration candidate selection prioritization unit 309 thereafter obtains a positive result at step SP32 by completing the same processing regarding all rows in which the value stored in the migration flag storage column 2803 is “TBD” among the rows of the file system migration control table 310, it refers to the inter-pool migration availability flag storage column 2603 (FIG. 26) of the selection prioritization condition table 303 (FIG. 26), and determines whether the migration of the file system is allowed to be performed across different pools (SP38). When the migration candidate selection prioritization unit 309 obtains a negative result in this determination, it changes the value of the migration flag storage column 2803 to “N” regarding all rows in which the value stored in the migration flag storage column 2803 is “TBD” among the rows of the file system migration control table 310. Further, migration candidate selection prioritization unit 309 deletes the contents of the used pool identifier storage column 2804 and the migration destination logical volume identifier list storage column 2805 regarding the foregoing rows, re-executes the calculation of the unused capacity of the respective pools after migration at step SP12, and thereafter ends this pool unused capacity check processing.

Meanwhile, when the migration candidate selection prioritization unit 309 obtains a positive result in this determination, it sets the pointer to the top row of the rows in which the value stored in the migration flag storage column 2803 is “TBD” among the rows of the file system migration control table 310 (SP39), and thereafter determines whether the processing of step SP41 to step SP45 described later has been performed to all rows in which the value stored in the migration flag storage column 2803 is “TBD” among the rows of the file system migration control table 310 (SP40).

When the migration candidate selection prioritization unit 309 obtains a negative result in this determination, it acquires the row number of the row to which the pointer is set in the file system migration control table 310 (SP41).

The migration candidate selection prioritization unit 309 determines whether there is unused capacity of the pool necessary for temporarily copying data for migrating the file system in the pool that is the same as the pool associated with the target file system based on the value stored in the file system total capacity utilization storage column 2704 of the corresponding row of the file system/virtual logical volume correspondence table 308, and the value stored in the POOL_A pre-migration unused capacity storage column 2806, the POOL_A post-migration unused capacity storage column 2807, the POOL_B pre-migration unused capacity storage column 2808, the POOL_B post-migration unused capacity storage column 2809, the POOL_C pre-migration unused capacity storage column 2810 and the POOL_C post-migration unused capacity storage column 2811 of the row of the row number that is one number smaller than the current row number of the file system migration control table 310 (SP42).

When the migration candidate selection prioritization unit 309 obtains a positive result in this determination, it updates the migration flag stored in the migration flag storage column 2803 of that row to “Y,” and then moves that row to the top of all rows in which the value stored in the migration flag storage column 2803 is “TBD” among the rows of the file system migration control table 310 (SP43). Further, the migration candidate selection prioritization unit 309 re-executes the calculation of the unused capacity of the respective pools after migration at step SP12 regarding all rows of the moved row onward. The migration candidate selection prioritization unit 309 changes the pointer set in the file system migration control table 310 to the next row of the row to which the pointer was moved (SP44), and thereafter returns to step SP40.

Meanwhile, when the migration candidate selection prioritization unit 309 obtains a negative result in this determination, it changes the pointer set in the file system migration control table 310 to the next row (SP45), and thereafter returns to step SP40.

When the migration candidate selection prioritization unit 309 thereafter obtains a positive result at step SP40 by completing the same processing regarding all rows in which the value stored in the migration flag storage column 2803 is “TBD” among the rows of the file system migration control table 310, it changes the value of the migration flag storage column 2803 to “N” regarding all rows in which the value stored in the migration flag storage column 2803 is “TBD” among the rows of the file system migration control table 310. Further, migration candidate selection prioritization unit 309 deletes the contents of the used pool identifier storage column 2804 and the migration destination logical volume identifier list storage column 2805 regarding the foregoing rows, re-executes the calculation of the unused capacity of the respective pools after migration at step SP12, and thereafter ends this pool unused capacity check processing.

(6-3) File System Usage Schedule Creation Processing

FIG. 36 shows the processing routine of creation processing (hereinafter referred to as the “file system usage schedule table creation processing”) of the file system usage schedule table 316 (FIG. 30) to be executed by the file system usage schedule creation unit 315 (FIG. 3) configuring the storage management software 132.

The file system usage schedule table creation processing is started periodically according to the scheduling setting when the operation mode of the storage management software 132 is set to “scheduled execution,” or started unconditionally after the collection processing performed by the agent information collection unit 301, or started after the collection processing performed by the application execution management information collection unit 313 only in cases when information concerning the application and the file system is changed in the resource configuration information 306. When the operation mode of the storage management software 132 is “manual,” the processing routine of FIG. 36 is not executed. The processing to be executed by the file system usage schedule creation unit 315 explained in FIG. 36, in reality, is executed by the CPU 129 that executes the storage management software 132.

When the file system usage schedule creation unit 315 starts the file system usage schedule table creation processing, it foremost determines whether the processing of step SP51 onward has been performed regarding all rows registered in the application execution schedule table 314 (FIG. 29) (SP50).

When the file system usage schedule creation unit 315 obtains a negative result in this determination, it reads the identifier, the execution start date and time and the execution end date and time of the application 122 respectively from the application identifier storage column 2901, the execution start date and time storage column 2902 and the execution end date and time storage column 2903 of unprocessed rows in the application execution schedule table 314 (SP51), and thereafter determines whether the processing of step SP53 to step SP55 has been fully performed to the application 122 (SP52).

When the file system usage schedule creation unit 315 obtains a negative result in this determination, it refers to the application/file system relationship table 1301 (FIG. 13) of the resource configuration information 306 (FIG. 3), reads one identifier of the unprocessed file systems associated with the application 122, which read the identifier at step SP51, in the application/file system relationship table 1301 from the application/file system relationship table 1301 (SP53), and determines whether the identifier of the file system is registered in the file system identifier list storage column 2702 of the file system/virtual logical volume correspondence table 308 (SP54).

When the foregoing file system identifier is not registered in the file system/virtual logical volume correspondence table 308, the file system usage schedule creation unit 315 returns to step SP52.

Meanwhile, when the foregoing file system identifier is registered in the file system/virtual logical volume correspondence table 308, the file system usage schedule creation unit 315 adds a new row to the file system usage schedule table 316 (FIG. 30), stores the file system identifier in the file system identifier storage column 3001 of the added row on the one hand, and stores the execution start date and time and the execution end date and time of the application 122 read from the application execution schedule table 314 at step SP51 respectively in the execution start date and time storage column 3002 and the execution end date and time storage column 3003 of the added row (SP55).

Subsequently, the file system usage schedule creation unit 315 returns to step SP52, and repeats step SP52 to step SP55 until it obtains a positive result at step SP52. If the application 122 acquired at step SP51 at such time is using a plurality of files systems, all of these file systems are registered in the file system usage schedule table 316.

When the file system usage schedule creation unit 315 eventually obtains a positive result at step SP52, it returns to step SP50, and thereafter repeats the same processing until it obtains a positive result at step SP50 (SP50 to SP55-SP50). Thereby, the usage schedule of the corresponding file system will be registered in the file system usage schedule table 316 regarding all rows registered in the application execution schedule table 314.

When the file system usage schedule creation unit 315 eventually obtains a positive result at step SP50, it ends this file system usage schedule table creation processing.

(6-4) File System Migration Schedule Table Creation Processing

FIG. 37 shows the processing routine of creation processing (hereinafter referred to as the “file system migration schedule table creation processing”) of the file system migration schedule table 318 (FIG. 31) to be executed by the migration schedule creation unit 317 (FIG. 3) configuring the storage management software 132.

When the operation mode of the storage management software 132 is “scheduled execution,” the file system migration schedule table creation processing is started periodically according to the scheduling setting, or started after the processing performed by the migration candidate selection prioritization unit 309, or started based on a request from the storage management client 103 triggered according to the user's command operation. When the operation mode of the storage management software 132 is “manual,” the file system migration schedule table creation processing is not executed. The processing to be executed by the migration schedule creation unit 317 explained in FIG. 37, in reality, is executed by the CPU 129 that executes the storage management software 132.

When the migration schedule creation unit 317 starts this file system migration schedule table creation processing, it foremost determines whether the processing of step SP61 onward has been fully performed regarding all rows of the file system migration control table 310 (FIG. 28) (SP60), and, upon obtaining a negative result, it acquires the information of the next row of the file system migration control table 310 (SP61). The migration schedule creation unit 317 acquires the information of the first row of the file system migration control table 310 in the initial processing.

Subsequently, the migration schedule creation unit 317 determines whether the migration flag stored in the migration flag storage column 2803 (FIG. 28) of the row from which information was acquired at step SP61 is “Y” or “N” (SP62), and returns to step SP60 if the migration flag is “N.” Contrarily, if the migration flag is “Y,” the migration schedule creation unit 317 selects the row of the file system/virtual logical volume correspondence table 308 (FIG. 27) storing the FS/VLV correspondence ID number that is the same as the FS/VLV correspondence ID number stored in the FS/VLV correspondence ID number storage column 2802 of that row. In addition, the migration schedule creation unit 317 determines whether the processing of step SP63 onward has been fully performed regarding the identifier of all file systems stored in the file system identifier list storage column 2702 of the selected row (SP63).

When the migration schedule creation unit 317 obtains a negative result in this determination, it selects the identifier of the unprocessed file system (SP64).

Subsequently, the migration schedule creation unit 317 refers to the corresponding capacity utilization storage column 2304 (FIG. 23) of the file system statistical information table 2301 (FIG. 23) of the resource statistical information 302 (FIG. 3), acquires the file system capacity of the identifier selected at step SP64, and calculates the duration required for migrating the file system from the acquired capacity (SP65).

Subsequently, the migration schedule creation unit 317 decides the migration start date and time, the scheduled migration end date and time and the migration discontinuance date and time of the file system so that the migration time frame of the file system does not overlap with the used time frame of the file system (so as to migrate the file system during a time frame while avoiding the time frame in which the file system is being used) based on the foregoing calculation result and the file system usage schedule table 316 (FIG. 30), and registers these in the file system migration schedule table 318 (SP66).

The migration schedule creation unit 317 thereafter returns to step SP63, and performs the same processing to the identifier of the unprocessed file system (SP63 to SP66-SP63).

When the migration schedule creation unit 317 obtains a positive result at step SP63, it returns to step SP60, and thereafter repeats the same processing until it obtains a positive result at step SP60. When the migration schedule creation unit 317 eventually ends the processing regarding all rows of the file system migration control table 310 (FIG. 28), it ends the file system migration schedule table creation processing.

(6-5) File System Migration Processing

FIG. 38 shows the processing routine of migration processing (hereinafter referred to as the “file system migration processing”) of the file system to be executed by the file system migration controller 321 (FIG. 3) configuring the storage management software 132.

When the operation mode of the storage management software 132 is “scheduled execution,” this file system migration processing is started periodically according to the scheduling setting. When the operation mode of the storage management software 132 is “manual,” file system migration processing is started based on the request from the storage management client 103 (FIG. 1) that received the pressing operation of the “migration execution” button 525 of the “migration execution” button 525 explained with reference to FIG. 5 or FIG. 6. The processing to be executed by the file migration controller 321 explained in FIG. 38, in reality, is executed by the CPU 129 that executes the storage management software 132.

When the file system migration controller 321 starts this file system migration processing, it determines whether the processing of step SP71 onward has been fully performed regarding all rows of the file system migration control table 310 (FIG. 28) (SP70), and, upon obtaining a negative result, it acquires the information of the next row of the file system migration control table 310 (SP71). The file system migration controller 321 acquires information of the first row of the file system migration control table 310 in the initial processing.

Subsequently, the file system migration controller 321 determines whether the migration flag stored in the migration flag storage column 2803 (FIG. 28) of the row from which information was acquired at step SP71 is “Y” or “N” (SP72), and returns to step SP70 if the migration flag is “N.” Contrarily, if the migration flag is “Y,” the file system migration controller 321 selects the row storing the same number as the FS/VLV correspondence ID number stored in the FS/VLV correspondence ID number storage column 2802 of the row from which information was acquired at step SP71 of the file system migration control table 310 in the FS/VLV correspondence ID number storage column 2701 (FIG. 27) among the rows of the file system/virtual logical volume correspondence table 308 (FIG. 27). Further, the migration schedule creation unit 317 acquires the defined capacity of the respective migration source logical volumes stored in the defined capacity storage column 1904 of the row searched from the logical volume table 1901 (FIG. 19) with the respective identifiers stored in the logical volume identifier list storage column 2703 (FIG. 27) of the selected row as the search key. Moreover, the file system migration controller 321 acquires the pool identifier stored in the used pool identifier storage column 2804 (FIG. 28) of the row from which information was acquired at step SP71, and the identifier of the respective migration destination logical volumes stored in the migration destination logical volume identifier storage column 2805 (FIG. 28). Subsequently, the file system migration controller 321 issues to the virtual volume management controller 149 of the storage apparatus 144 a volume creation command for creating a virtual logical volume having the identifier of the respective migration destination logical volumes in the pool having the acquired pool identifier in the same defined capacity as the defined capacity of each of the acquired migration source logical volumes (SP73). Thereby, the virtual logical volume of a capacity designated in the corresponding pool of the storage apparatus 144 is created by the virtual volume management controller 149 of the storage apparatus 144 according to the volume creation command.

Subsequently, the file system migration controller 321 issues a file system duplication preparation command to the file system migration execution unit 121 of the host server 113 (SP74). The duplication preparation command is executed by being converted into a command to the file management system 124 and the volume management software 125 by the file system migration execution unit 121, a data I/O path between the migration destination virtual logical volume and the host server 113 created at SP73 is thereby set, and the data I/O request enters an issuable status via the file management system 124 and the volume management software 125. Subsequently, the file system migration controller 321 determines whether the processing of step SP76 onward has been fully performed to the file system of all identifiers stored in the file system identifier list storage column 2702 (FIG. 27) of the row of the file system/virtual logical volume correspondence table 308 (FIG. 27) selected at step SP73 (SP75).

When the file system migration controller 321 obtains a negative result in this determination, it selects an unprocessed identifier among the file system identifiers stored in the file system identifier storage column 2702 (FIG. 27) of the row of the file system/virtual logical volume correspondence table 308 (FIG. 27) selected at step SP73 (SP76).

Subsequently, the file system migration controller 321 refers to the file system migration schedule table 318 (FIG. 31), acquires the migration start date and time, the migration end date and time and the migration discontinuance date and time of the file system identifier selected at step SP76, and waits for the time to reach the migration start date and time (SP77). When the time reaches the migration start date and time, the file system migration controller 321 issues a file system duplication command to the file system migration execution unit 121 of the host server 113 (SP78).

Consequently, as a result of the file system migration execution unit 121 issuing a data I/O request to the file management system 124 according to the file system duplication command, the copying of data of the corresponding file system is started. When the copying of such file system is complete, the file system migration execution unit 121 reports this to the file system migration controller 321. If the copy ends in a failure due to the unused capacity of the migration destination pool falling short during the copying of the file system, the file system migration execution unit 121 also reports this to the file system migration controller 321.

Meanwhile, after the file system migration controller 321 sends the file system duplication command to the file system migration execution unit 121, it waits for a given period of time to lapse (SP79), and thereafter determines whether the report of copy completion or copy failure due to insufficient unused capacity has been issued from the file system migration execution unit 121, and whether the current date and time has reached the migration discontinuance date and time of the file system acquired at step SP77 (SP80).

If the file system migration controller 321 determines at step SP80 that a report of copy completion or copy failure due to insufficient unused capacity has not been issued from the file system migration execution unit 121, and the current date and time has not reached the migration discontinuance date and time of the file system acquired at step SP77, it returns to step SP79, and thereafter repeats the same processing until the report of copy completion or copy failure due to insufficient unused capacity is issued from the file system migration execution unit 121, and the current date and time reaches the migration discontinuance date and time of the file system acquired at step SP77 is issued at step SP80 (SP80-SP79-SP80).

When the file system migration controller 321 eventually receives a copy completion report from the file system migration execution unit 121, it issues a file system replacement command to the file system migration execution unit 121 (SP81), and thereafter returns to step SP75. This replacement command is executed as an unmount and mount command of the migration source and migration destination virtual logical volume to the file management system 124 by the file system migration execution unit 121, and the file system of the migration source and the file system of the migration destination are replaced.

The file system migration controller 321 thereafter repeats the processing of step SP75 to step SP81 until it obtains a positive result at step SP75, or the current date and time becomes the migration discontinuance data of the file system acquired at step SP77, or a copy failure report caused by the shortage of unused capacity of the migration destination pool is issued from the file system migration execution unit 121. Thereby, the file system of all identifiers stored in the file system identifier list storage column 2702 (FIG. 27) of the row of the file system/virtual logical volume correspondence table 308 (FIG. 27) selected at step SP73 will be migrated according to the schedule.

When the file system migration controller 321 obtains a positive result at step SP75 as a result of completing the migration of all file systems, it issues a file system post-migration processing command to the file system migration execution unit 121 (FIG. 1) of the host server 113 (SP83). Thereby, the data I/O path between the migration source virtual logical volume and the host server 113 will be cancelled according this file system post-migration processing command.

The file system migration controller 321 thereafter a volume deletion command to the virtual volume management controller 149 of the storage apparatus for deleting the migration source virtual logical volume of the file system (SP84), and then returns to step SP70. Thereby, the virtual volume management controller 149 deletes the migration source virtual logical volume of the file system, and, as a result, the storage area of the migration source virtual logical volume is released. In the foregoing case, the unused capacity of the migration source virtual logical volume, which is the difference between the capacity of the migration source virtual logical volume of the file system and the capacity of the migration destination virtual logical volume of the file system, is collected.

When the current date and time becomes the migration discontinuance data of the file system acquired at step SP77, or a copy failure report caused by the shortage of unused capacity of the migration destination pool is issued from the file system migration execution unit 121 at step SP80, the file system migration controller 321 executes error processing such as displaying an error message on the storage management client 103 (FIG. 1) (SP82), and thereafter returns to step SP70.

Meanwhile, when the file system migration controller 321 returns to step SP70, it thereafter repeats the processing of step SP71 to step SP84 until the same processing is fully performed to all rows of the file system migration control table 310 (FIG. 28). When the file system migration controller 321 eventually completes performing the same processing to all rows of the file system migration control table 310, it ends this file system migration processing.

### (7) Effect of Present Embodiment

As described above, since the computer system 100 detects the unused capacity of the respective file systems and the virtual logical volumes associated therewith, migrates the data of such file systems to other virtual logical volumes when the unused capacity exceeds a threshold value, and deletes the migration source virtual logical volume, it is possible to collect the unused capacity of the virtual logical volume. Consequently, it is possible to support and execute the storage operation and management capable of improving the utilization ratio of storage resources.

### (8) Other Embodiments

Although the foregoing embodiments explained a case of periodically executing the file system migration processing explained with reference to FIG. 38, the present invention is not limited thereto, and, for instance, the file system migration can also be executed when the unused capacity of the virtual logical volume allocated to the file system exceeding the threshold value.

Although the foregoing embodiments explained a case of realizing the function as the first capacity utilization acquisition unit for acquiring the capacity utilization of the virtual logical volume by the file system, the function as the second capacity utilization acquisition unit for acquiring the capacity utilization of the virtual logical volume, and the function as the file system migration unit for migrating the file system to another virtual logical volume and deleting the migration source virtual logical volume with the storage management software 132 of the storage management server 127, the present invention is not limited thereto, and these functions may be loaded in the host server 113 or other apparatuses.

Similarly, although the foregoing embodiments explained a case of configuring the display unit for associating and displaying the capacity utilization of the file system and the capacity utilization of the corresponding virtual logical volume with the storage management software 132 and the storage management client 103 of the storage management server 127, the present invention is not limited thereto, and the function as the display unit may be loaded in the host server 113 or other apparatuses.

The present invention can be broadly applied to computer systems of various configurations including a storage apparatus equipped with the AOU function.

What is claimed is:

1. A management apparatus for managing a storage apparatus equipped with a function for providing a virtual logical volume to a host system, and dynamically allocating a storage area to said virtual logical volume upon receiving a write request for writing data into said virtual logical volume, comprising:
a first capacity utilization acquisition unit for acquiring the capacity utilization of said virtual logical volume by a file system in which data is stored in said virtual logical volume by said host system;
a second capacity utilization acquisition unit for acquiring the capacity utilization of said virtual logical volume configured from the capacity of said storage area allocated to said virtual logical volume; and
a display unit for associating and displaying the capacity utilization of said file system and the capacity utilization of the corresponding virtual logical volume respectively acquired by said first and second capacity utilization acquisition units.

2. The management apparatus according to claim 1,
wherein said display unit displays a list of the capacity utilization of said file system and the capacity utilization of the corresponding virtual logical volume in order according to the size or ratio of the unused capacity of said virtual logical volume regarding a plurality of pairs of said file system and the corresponding virtual logical volume.

3. The management apparatus according to claim 2,
wherein said display unit lowers said order or does not display the capacity utilization of said file system and the capacity utilization of said virtual logical volume regarding said pair of said file system in which said capacity utilization exceeds the unused capacity of a pool providing said storage area to the corresponding virtual logical volume, and said virtual logical volume.

4. The management apparatus according to claim 2,
wherein said display unit lowers said order or does not display the capacity utilization of said file system and the capacity utilization of said virtual logical volume regarding said pair of said file system in which said capacity utilization increases or decreases with time, and said virtual logical volume corresponding to said file system.

5. The management apparatus according to claim 1,
wherein said display unit manages the capacity utilization history of one or more said file systems, and displays the capacity utilization history of the designated file system.

6. The management apparatus according to claim 1,
further comprising a file system migration unit for migrating data of said file system, in which said capacity utilization was associated with the capacity utilization of the corresponding virtual logical volume and displayed on said display unit, to another virtual logical volume, and deleting said virtual logical volume of the migration source.

7. A management method for managing a storage apparatus equipped with a function for providing a virtual logical volume to a host system, and dynamically allocating a storage area to said virtual logical volume upon receiving a write request for writing data into said virtual logical volume, comprising:
a first step for acquiring the capacity utilization of said virtual logical volume by a file system in which data is stored in said virtual logical volume by said host system, and acquiring the capacity utilization of said virtual logical volume configured from the capacity of said storage area allocated to said virtual logical volume; and
a second step for associating and displaying the capacity utilization of said file system and the capacity utilization of the corresponding virtual logical volume.

8. The management method according to claim 7,
wherein, at said second step, a list of the capacity utilization of said file system and the capacity utilization of the corresponding virtual logical volume is displayed in order according to the size or ratio of the unused capacity of said virtual logical volume regarding a plurality of pairs of said file system and the corresponding virtual logical volume.

9. The management method according to claim 8,
wherein, at said second step, said order is lowered or the capacity utilization of said file system and the capacity utilization of said virtual logical volume are not displayed regarding said pair of said file system in which said capacity utilization exceeds the unused capacity of a pool providing said storage area to the corresponding virtual logical volume, and said virtual logical volume.

10. The management method according to claim 8,
wherein, at said second step, said order is lowered or the capacity utilization of said file system and the capacity utilization of said virtual logical volume are not displayed regarding said pair of said file system in which said capacity utilization increases or decreases with time, and said virtual logical volume corresponding to said file system.

11. The management method according to claim 7,
wherein, at said second step, the capacity utilization history of one or more said file systems is managed, and the capacity utilization history of the designated file system is displayed.

12. The management method according to claim 7,
further comprising a third step for migrating data of said file system, in which said capacity utilization was associated with the capacity utilization of the corresponding virtual logical volume and displayed on said display unit, to another virtual logical volume, and deleting said virtual logical volume of the migration source.

13. A management apparatus for managing a storage apparatus equipped with a function for providing a virtual logical volume to a host system, and dynamically allocating a storage area to said virtual logical volume upon receiving a write request for writing data into said virtual logical volume, comprising:
a first capacity utilization acquisition unit for acquiring the capacity utilization of said virtual logical volume by a file system in which data is stored in said virtual logical volume by said host system;
a second capacity utilization acquisition unit for acquiring the capacity utilization of said virtual logical volume configured from the capacity of said storage area allocated to said virtual logical volume; and
a file system migration unit for migrating data of said file system, in which the difference between said capacity utilization and the capacity utilization of the corresponding virtual logical volume exceeds a predetermined threshold value, to another virtual logical volume, and deleting said virtual logical volume of the migration source.

14. The management apparatus according to claim 13,
wherein said file system migration unit migrates the data of said file system in order according to the size or ratio of the unused capacity of said virtual logical volume regarding a plurality of pairs of said file system and the corresponding virtual logical volume.

15. The management apparatus according to claim 14,
wherein said file system migration unit lowers said order or does not migrate the data of said file system regarding said pair of said file system in which said capacity utilization exceeds the unused capacity of a pool providing said storage area to the corresponding virtual logical volume, and said virtual logical volume.

16. The management apparatus according to claim 14,
wherein said file system migration unit lowers said order or does not migrate the data of said file system regarding said pair of said file system in which said capacity utilization increases or decreases with time, and said virtual logical volume corresponding to said file system.

17. The management apparatus according to claim 13,
further comprising a usage schedule acquisition unit for acquiring the usage schedule of said file system,
wherein said file system migration unit migrates the data of said file system to said other virtual logical volume during a time frame which avoids the time frame that said file system subject to migration will be used based on the usage schedule of said file system acquired with said usage schedule acquisition unit.

18. A management method for managing a storage apparatus equipped with a function for providing a virtual logical volume to a host system, and dynamically allocating a storage area to said virtual logical volume upon receiving a write request for writing data into said virtual logical volume, comprising:
a first step for acquiring the capacity utilization of said virtual logical volume by a file system in which data is stored in said virtual logical volume by said host system, and acquiring the capacity utilization of said virtual logical volume configured from the capacity of said storage area allocated to said virtual logical volume; and
a second step for migrating data of said file system, in which the difference between said capacity utilization and the capacity utilization of the corresponding virtual logical volume exceeds a predetermined threshold value, to another virtual logical volume, and deleting said virtual logical volume of the migration source.

19. The management method according to claim 18,
wherein, at said second step, the data of said file system is migrated in order according to the size or ratio of the unused capacity of said virtual logical volume regarding a plurality of pairs of said file system and the corresponding virtual logical volume.

20. The management method according to claim 19,
wherein, at said second step, said order is lowered or the data of said file system is not migrated regarding said pair of said file system in which said capacity utilization exceeds the unused capacity of a pool providing said storage area to the corresponding virtual logical volume, and said virtual logical volume.

21. The management method according to claim 19,
wherein, at said second step, said order is lowered or the data of said file system is not migrated regarding said pair of said file system in which said capacity utilization increases or decreases with time, and said virtual logical volume corresponding to said file system.

22. The management method according to claim 18,
further comprising a step for acquiring the usage schedule of said file system,
wherein, at said second step, the data of said file system is migrated to said other virtual logical volume during a time frame which avoids the time frame that said file system subject to migration will be used based on the acquired usage schedule of said file system.
